(19) United States
(12) Patent Application Publication
(10) Pub. No.: US 2011/0165376 A1
(43) Pub. Date: Jul. 7, 2011

(54) Process for making a filled asphalt composition

(76) Inventors: Robert H. Whitaker, Cleveland, GA (US); Allen E. Smith, Sparta, NJ (US); David R. Puryear, Nashville, TN (US)

(21) Appl. No.: 12/927,442

(22) Filed: Nov. 15, 2010

Related U.S. Application Data
(63) Continuation-in-part of application No. 11/405,966, filed on Apr. 18, 2006, now Pat. No. 7,833,339.

(51) Int. Cl. B32B 3/30; C04B 24/36

(52) U.S. Cl. 428/148; 106/668

(57) ABSTRACT

A process for making a composition of asphalt and filler in which a viscosity reducing additive is sprayed onto particles of shingle filler material to produce coated shingle filler material, the coated shingle filler material is heated, asphalt is heated, and the heated coated shingle filler material is mixed with the heated asphalt.

### CROSS-REFERENCE TO RELATED PATENT APPLICATIONS

This application is a continuation-in-part of copending patent application Ser. No. 11/405,966, filed on Apr. 18, 2006. The entire disclosure of such copending patent application is hereby incorporated by reference into this specification.

### FIELD OF THE INVENTION

A process for making a composition comprised of asphalt and filler wherein a viscosity-reducing additive is sprayed onto particles of calcium carbonate to form coated calcium carbonate particles, and the coated particles and then mixed with a heated asphalt material.

### BACKGROUND OF THE INVENTION

Asphalt shingles are made by a process in which asphalt is mixed with inorganic filler material to make a filled asphalt coating, and the filled asphalt coating thus produced is used to saturate and coat a glass fabric mat. In this process, it is desired that the viscosity of the asphalt/filler material be sufficiently low so as to allow efficient processing at relatively high production rates.

The viscosity of the filled asphalt coating used in this process can often be a limiting factor in achieving complete saturation of the glass fabric. Such viscosity is typically a function of, e.g., the type of asphalt used, the level of inorganic filler in the asphalt coating, the type of inorganic filler used, and the temperature of the filled asphalt coating.

As the viscosity of the filled asphalt coating increases above certain ranges, the glass fabric mat may not be fully saturated, and thin or uncoated spots, bubbles or voids may be created which may lead to premature failure of the roofing shingle.

When the viscosity of the filled asphalt coating increases to unacceptable levels, the roofing shingle manufacturer must compensate for this increased viscosity by, reducing the “process line speed” and/or increasing the temperature of the filled asphalt coating and/or reducing the amount of filler in the asphalt/filler composition.

The problem with decreasing the “process line speed” is that it results in decreased productivity.

The problem with increasing the temperature of the filled asphalt coating is described, e.g., in U.S. Pat. No. 4,634,622, the entire disclosure of which is hereby incorporated by reference into this specification. This patent discloses that “Because asphalt is more expensive than the conventional filler material, the use of less asphalt overall, without reducing the amount of filler, has been tried by others. The result has been a cheaper roofing product, but one which cannot weather to the same level as product with more of the same quality asphalt. Further, a significant reduction in asphalt can create processing problems. The more the amount of asphalt in a given mix is reduced, the higher the concentration of filler in the mix. This increases the viscosity of the mix and could cause flow problems through the processing conditions. One way to combat this is to heat the asphalt or the filler or both, since the addition of heat will lower the viscosity. The addition of heat over and above the standard processing temperatures, however, would move the temperature of the asphalt closer to its flashpoint.”

The problem with reducing the amount of filler in the asphalt/filler composition is that, as is indicated in such U.S. Pat. No. 4,634,622, “ . . . asphalt is more expensive than the conventional filler material . . . .”

It is an object of this invention to provide a process for making a filled asphalt coating composition that can be used to efficiently produce good roofing shingles that are relatively inexpensive and have good mechanical and other properties.

It is another object of this invention to provide a filled asphalt coating composition with a filler loading of from about 70 to about 80 weight percent. It is yet another object of this invention to provide a shingle made from such filled asphalt composition.

### SUMMARY OF THE INVENTION

In accordance with one embodiment of this invention, there is provided a process for making a composition comprised of asphalt and filler.

In one step this process, a viscosity-reducing additive is sprayed onto particles of shingle filler material that are comprised of limestone in order to provide coated particles of such shingle filler material; and the coated filler material is then heated.

In another step of this process, an asphalt is chosen, and the asphalt is heated.

The heated filler material and the heated asphalt are then mixed. The viscosity of the mixture is then tested at elevated temperatures to determine the efficacy of the viscosity-reducing additive.

In one embodiment, the mixture of heated filler material and heated asphalt is used to produce a roofing shingle that, in one aspect of this embodiment, is tested to determine its properties. Thereafter, as appropriate, the filler material and/or the asphalt material may be changed, and the process may be repeated until the optimum mixture of asphalt and filler material is obtained.

### BRIEF DESCRIPTION OF THE DRAWINGS

The invention will be described by reference to the following drawings, in which like numerals refer to like elements, and wherein:

FIG. 1 is a flow diagram of one preferred process of the invention; and

FIG. 2 is a schematic of a viscosity testing apparatus.

### DESCRIPTION OF THE PREFERRED EMBODIMENTS

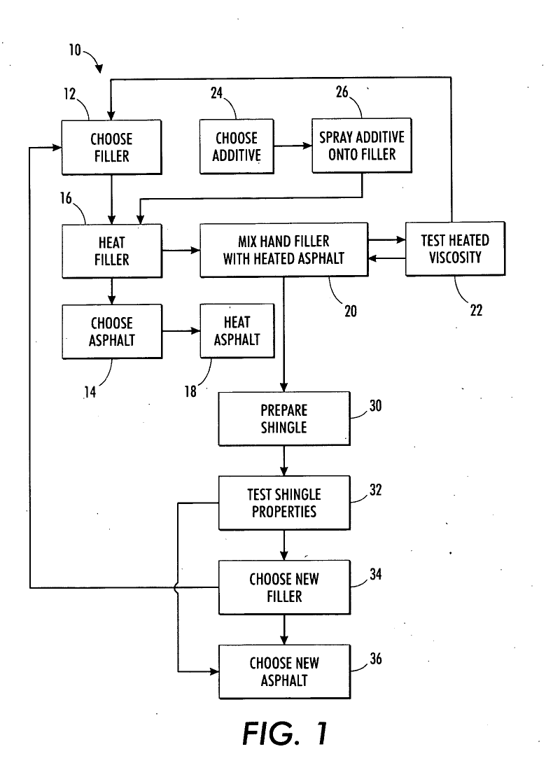

FIG. 1 illustrates a preferred process 10 for making a mixture of asphalt and filler material. In step 12 of such process, a filler material that is comprised of calcium carbonate is chosen for use in the process.

One may use any of the filler materials comprised of calcium carbonate that have heretofore been used for to fill asphalt for this purpose; some of these materials are described in applicants' published United States patent application US 2007/0261337.

Applicants' published United States patent application US 2007/0261337, the entire disclosure of which is hereby incorporated by reference into this specification, describes and claims several different filler materials that may be chosen for use in step 12 of the process.

The following claims of published United States patent application U.S. 2007/0261337 describe one or more filler materials that may be used in step 12 of the process of this invention.

“1. A composition comprised of asphalt and filler, wherein said filler is comprised of particles that comprise an inorganic core and a coating disposed on said core, and wherein at least about 60 weight percent of said particles are smaller than about 212 microns.”

“2. The composition as recited in claim 1, wherein said inorganic core is a core of limestone.”

“10. A composition comprised of asphalt and filler, wherein said filler is comprised of a multiplicity of particles which are smaller than about 212 microns, and wherein said composition has a viscosity index of less than about 0.9.”

“11. The composition as recited in claim 10, wherein said filler is a mineral filler.’

“12. The composition as recited in claim 11, wherein said composition is comprised of from about 71 to about 75 weight percent of said mineral filler composition.”

“13. The composition as recited in claim 10, wherein said composition is comprised of less than about 70 weight percent of said mineral filler composition.”

“16. A composition comprised of from about 71 to about 75 weight percent of mineral filler material with a particle size less than 212 microns and from about 25 to about 29 weight percent of asphalt (by combined weight of said asphalt and said mineral filler with a particle size smaller than 212 microns) wherein, when said composition is incorporated into a glass felt mat with a density of from about 1.8 to about 1.9 pounds per 100 square feet and made into a single-layer roofing shingle, said shingle, after having been subjected to at least 10 cycles of Cycle A of ASTM standard test D 4798-04, has a tear resistance of at least 1,700 grams.”

“17. The composition as recited in claim 10, wherein said mineral filler with a particle size less than 212 microns is limestone.”

“18. The composition as recited in claim 11, wherein said limestone is comprised of at least about 90 weight percent of calcium carbonate.”

‘19. The composition as recited in claim 12, wherein, when 50 grams of said limestone are disposed in 100 cubic centimeters of water, less than about 2 grams of said water are absorbed by said 50 grams of said limestone.”

“20. The composition as recited in claim 13, wherein said limestone is comprised of at least 60 percent of particles less than 212 microns in size but greater than 74 microns in size.”

“21. The composition as recited in claim 14, wherein less than about 2 weight percent of said particles of said limestone are greater than 250 microns.”

“33. A mineral filler material with a particle size less of than about 212 microns wherein, when said mineral filler material is mixed with asphalt to produce a roofing composition that is comprised of from about 25 to about 29 weight percent of asphalt and from about 75 to about 71 weight percent of said mineral filler composition, (by combined weight of said asphalt and said mineral filler material), and wherein when said composition is incorporated into a glass felt mat with a density of from about 1.8 to about 1.9 pounds per 100 square feet and made into a multi-layer roofing shingle, said shingle, when tested for at least 10 cycles of Cycle A of ASTM standard test D 4798-04, will have a fastener pull-through resistance at a temperature of 23 degrees Celsius of at least about 135 Newton's.”

“34. A mineral filler material with a particle size less of than about 212 microns wherein, when said mineral filler material is mixed with asphalt to produce a roofing composition that is comprised of from about 25 to about 29 weight percent of asphalt and from about 75 to about 71 weight percent of said mineral filler material (by combined weight of said asphalt and said mineral filler material), and wherein when said composition is incorporated into a glass felt mat with a density of from about 1.8 to about 1.9 pounds per 100 square feet and made into a single-layer roofing shingle, said shingle, when tested for at least 10 cycles of Cycle A of ASTM standard test D 4798-04, will have a fastener pull-through resistance at a temperature of 0 degrees Celsius of at least about 104 Newton's.”

“35. A mineral filler material with a particle size less of than about 212 microns wherein, when said mineral filler material is mixed with asphalt to produce a roofing composition that is comprised of from about 25 to about 29 weight percent of asphalt and from about 75 to about 71 weight percent of said mineral filler material (by combined weight of said asphalt and said mineral filler material), and wherein when said composition is incorporated into a glass felt mat with a density of from about 1.8 to about 1.9 pounds per 100 square feet and made into a multi-layer roofing shingle, said shingle, when tested for at least 10 cycles of Cycle A of ASTM standard test D 4798-04, will have a fastener pull-through resistance at a temperature of 0 degrees Celsius of at least about 180 Newton's.”

In applicants' prior application (U.S. Ser. No. 11/405,966), the following claims were presented to roofing shingles:

“36. A roofing shingle that, after it has been subjected to at least 10 cycles of Cycle A of ASTM standard test D 4799-03, will have a tear resistance of at least 1,700 grams, wherein said shingle is comprised of a roofing composition disposed within a glass felt mat, and wherein said roofing composition is comprised of from about 25 to about 29 weight percent of asphalt and from about 75 to about 71 weight percent of mineral filler material with a particle size of less than about 212 microns (by combined weight of said asphalt and said mineral filler material).”

“37. The roofing shingle as recited in claim 31, wherein said mineral filler material with a particle size less than 212 microns is limestone.”

“38. The roofing shingle as recited in claim 32, wherein said limestone is comprised of at least about 90 weight percent of calcium carbonate.”

“39. The roofing shingle as recited in claim 32, wherein said limestone is comprised of at least 60 percent of particles less than 212 microns in size but greater than 74 microns in size.”

“40. The roofing shingle as recited in claim 32, wherein less than about 2 weight percent of said particles of said limestone are greater than 250 microns.”

“41. The roofing shingle as recited in claim 32, wherein said composition is comprised of from about 25 to about 28 percent of said asphalt.”

“42. The roofing shingle as recited in claim 32, wherein said composition is comprised of from about 25 to about 27 percent of said asphalt.

“43. The roofing shingle as recited in claim 32, wherein said roofing shingle, after having been subjected to at least 10 cycles of Cycle A of ASTM standard test D 4798-04, has a Class 1 impact resistance, as measured by Underwriter's Laboratory standard test UL 2218.”

“44. The roofing shingle as recited in claim 32, wherein said roofing shingle, after having been subjected to at least 10 cycles of Cycle A of ASTM standard test D 4798-04, has a Class 2 impact resistance, as measured by Underwriter's Laboratory standard test UL 2218.”

“45. The roofing shingle as recited in claim 32, wherein said roofing shingle, after having been subjected to at least 10 cycles of Cycle A of ASTM standard test D 4798-04, has a Class 3 impact resistance, as measured by Underwriter's Laboratory standard test UL 2218.

Similar roofing shingle claims are presented in the instant application.

Referring again to FIG. 1, alternatively, in such step 12 of process 10 the filler used may have the particle size distribution described in U.S. Pat. No. 6,605,902, the entire disclosure of which is hereby incorporated by reference into this specification. Thus, e.g., such filler may have “ . . . a particle size distribution having at least three modes.” (claim 1), or it may include “ . . . a first mode having a median particle diameter from 0.3 to 1.0 microns, a second mode having a median particle diameter from 10 to 25 microns, and a third mode having a median particle diameter from 40 to 80 microns.” (claim 2), or it may have a filler loading “ . . . of greater than 70% by weight.” (claim 9).

In such step 12 of process 10, the filler chosen may be comprised of at least 90 percent of limestone particles with a particle size distribution such at least 98 percent of the limestone particles pass a number 30 mesh screen (0.590 millimeters) and at least 60 percent of the particles pass a number 200 sieve (73.7 microns). In one aspect of this embodiment, at least 75 percent of the limestone particles pass a 200 sieve.

By way of illustration, one suitable limestone that may be used in this embodiment is “A85/200” limestone produced by Franklin Industrial Minerals of 9020 Overlook Blvd., Suite 200, Brentwood, Tenn. 37027. This product contains material with a particle size distribution such that at least 99 percent of the particles pass a 60 mesh screen, and at least 78 percent of the particles pass a 200 mesh sieve. This material contains at least 96 percent of calcium carbonate.

The process 10 is suitable for a wide range of limestone fillers and asphalts. Once the particular filler one wants to use is chosen (in step 12), its effect upon the viscosity of hot asphalt is determined to establish a baseline value against which the effects of various additives that may be incorporated into such filler may be measured.

### Dedusted Limestone Materials

In one embodiment, the filler material used in the process of this patent is a dedusted limestone material produced in substantial accordance with the procedure described in applicants' U.S. Pat. No. 7,651,559, the entire disclosure of which is hereby incorporated by reference into this specification.

As is disclosed in U.S. Pat. No. 7,651,559, “Referring again to FIG. 1, a portion of the material screened in multideck screener 30 may be fed via line 32 to air flow separator 34, in which the concentration of ‘fines content’ of such material . . . is reduced.”

U.S. Pat. No. 7,659,551 also discloses that: “Airflow separators are well known to those skilled in the art, and they are referred to in the claims of U.S. Pat. Nos. 5,541,831 (computer controlled separator device), 5,943,231 (computer controlled separator device), 6,351,676 (computer controlled separator device), and the like. The entire disclosure of each of these United States patents is hereby incorporated by reference into this specification.”

U.S. Pat. No. 7,659,551 also discloses that “Air separators are also discussed in U.S. Pat. Nos. 3,772,857 (water air separator), 3,874,444 (duo-baffle air separator apparatus), 3,877,454 (air separator), 3,962,072 (air separator apparatus), 4,662,915 (powder air separator), 4,824,559 (rotary air separator), 5,244,481 (vertical air separator), 5,788,727 (centrifugal air separator), 6,053,967 (air separator), 6,664,479 (method and air separator for classifying charging material reduced in size), and the like.”

U.S. Pat. No. 7,659,551 discloses that air separation technology may be used to reduce the “fines content” of limestone materials. In one embodiment, such air separation technology is used to reduce the fines content of filler grade limestone material.

There are many filler grade limestone materials that have at least 60 percent of their particle smaller than 212 microns that may be processed by such air separation technology. By way of illustration, and not limitation, one of such material is sold the Lowell Plant of Franklin Industrial Minerals (11661 Northwest Gainesville Road, Ocala, Fla. 34482) as “L60/200;” this material contains less than 0.1 percent of material greater than 20 mesh (841 microns), and from 44 to 72 percent of material smaller than 74 microns. In one embodiment, such “L60/200” filler is “dedusted” until it contains less than 10 weight percent of “fines” that are smaller than 10 microns; and it also may be advantageously used in applicants' process.

By way of further illustration, the material that contains at least 60 weight percent of particles smaller than 212 microns also has at least 40 percent of its particles smaller than 74 microns. In one aspect of this embodiment, this material is dedusted until it contains less than 10 weight percent of “fines” smaller than 10 microns.

By way of further illustration, the material that contains at least 75 weight percent of particles smaller than 212 microns and at least 40 percent of such material is less than 74 microns. In one aspect of this embodiment, this material is dedusted until it contains less than 10 weight percent of “fines” smaller than 10 microns.

By way of further illustration, the material that contains at least 50 weight percent of particles smaller than 74 microns also less than 10 weight percent of such particles smaller than 50 microns.

By way of further illustration, the material contains at least 60 weight percent of particles smaller than 212 microns also has at least 40 percent of its particles smaller than 74 microns. In one aspect of this embodiment, this material is dedusted until it contains less than 10 weight percent of “fines” than 10 microns.

In the remainder of this specification, applicants will describe a process in which the limestone filler material is coated with certain additives and the coated filler material is then mixed with asphalt. In one alternative embodiment, some of the additive material is used to coat the limestone particles, and some of the additive material is added to the asphalt. In another embodiment, all of substantially all of the additive material is added to the asphalt and substantially none of such material is used to coat the filler.

### The Asphalt Used in the Process of the Invention

In step 14 of the process 10 of this invention, an asphalt material is chosen. One may use any of the roofing shingle coating asphalts commonly used.

As is known to those skilled in the art, and as is disclosed in published United States patent US 2009/0004387 (the entire disclosure of which is hereby incorporated by reference into this specification), “Roofing shingle coating asphalts are usually produced by selecting a suitable feedstock asphalt and then processing that asphalt by air blowing to provide the properties desired for use in a coating asphalt. For example, asphalt feedstocks used to produce coating asphalts for roofing shingles are usually chosen so that they can be air-blown to: 1) raise their softening point so that they maintain their dimensions at high temperatures on a roof; 2) lower their penetration into a range where it allows proper press of granules without becoming too brittle; 3) raise their melt viscosity so that when filler is added the filled coating viscosity is in a range that allows a roofing shingle process to run at high speeds; and 4) create a shingle that will perform over many years on the roof in spite of being exposed to sun, high temperatures and rain” (see paragraph [0002]).

In paragraph [0003] of published United States patent application US 2009/0004387, it is disclosed that: “Historically coating asphalt for roofing shingles has been produced by choosing a special grade of asphalt as the feedstock to the air blowing process in order to meet these properties. These special grades of asphalt were often materials that were softer (higher penetration, lower viscosity) than paving grade asphalt and were often called “roofer's flux”. In addition to being softer they needed to have high flash points to allow the final coating to be heated to high temperatures in preparation for mixing with filler and coating a glass fiber mat, and they needed to have the characteristics that once air blown to coating they exhibited excellent durability to weather. Unfortunately, these special grades of asphalt that can be air-blown to make coating asphalts are increasingly in short supply and therefore can be costly compared to many other types of asphalt, particularly commodity paving asphalts. A new process that increases material opportunities in the production of roofing shingle coating asphalt would be beneficial to the asphalt roofing product business.”

In paragraph [0004] of published United States patent application US 2009/0004387, it is disclosed that: “Asphalts have been modified with waxes to produce a variety of roofing and industrial products. For example, Chang et al. (U.S. Pat. No. 4,382,989) discloses a roofing asphalt formulation containing oxidized coating grade asphalt, oxidized polyethylene and optionally saturant asphalt and filler. In one embodiment, the asphalt is oxidized to any degree, then unoxidized polyethylene is added, and then the oxidation process is continued to produce the roofing asphalt formulation. In a later improvement Chang et al. (U.S. Pat. No. 4,497,921) added sulfur to stabilize the mix. Janicki (U.S. Pat. No. 4,554,023) claimed a method of making a roofing shingle asphalt by blending bis-stearoylamide wax into asphalt, including blown asphalt, particularly asphalts with 143° F. softening points, with a benefit of lowering the viscosity of the asphalt product.”

Thus, and in one embodiment, one may prepare a coating asphalt for use in step 14 of this process by the process described in United States published patent application US 2009/0004387, the entire disclosure of which is hereby incorporated by reference into this specification. Claim 1 of this published patent application describes: “1. A process of producing a roofing shingle coating asphalt from a low flashpoint asphalt feedstock comprising: partially blowing an asphalt feedstock which has a low flashpoint within a range of from about 490° F. (254° C.) to about 540° F. (282° C.); and adding wax to the asphalt feedstock; the process producing a coating asphalt having a low melt viscosity within a range of from about 50 cps to about 150 cps at 400° F. (204° C.), a softening point within a range of from about 190° F. (88° C.) to about 235° F. (113° C.) and a penetration of at least about 15 dmm at 77° F. (25° C.).”

Thus, and in another embodiment, one may prepare a coating asphalt for use in step 14 of this process by the process described in published United States patent application 2009/0000514, the entire disclosure of which is hereby incorporated by reference into this specification. Claim 1 of this published patent application describes: ‘1. A method of producing a roofing shingle coating asphalt from a non-coating grade asphalt feedstock comprising the following steps: partially blowing the non-coating grade asphalt feedstock to lower its penetration to a first penetration that is within or close to a target penetration range of the coating asphalt, and to raise its softening point to a first softening point that is lower than a target softening point range of the coating asphalt; adding a blowing catalyst to the non-coating grade asphalt before or during the blowing; and then adding a wax to the partially blown non-coating grade asphalt to further raise its softening point to a second softening point that is within the target softening point range, to produce the coating asphalt.”

Thus, and in yet another embodiment, one may make the coating asphalt for use in step 14 of this process by the process described in published United States patent application 2009/0000515, the entire disclosure of which is hereby incorporated herein by reference. Claim 1 of this published patent application describes: “1. A process of producing a roofing shingle coating asphalt from an asphalt feedstock comprising the following steps: adding wax and blowing catalyst to the asphalt feedstock; and then blowing the asphalt feedstock to produce the coating asphalt; the coating asphalt having a softening point within a range of from about 190° F. (88° C.) to about 235° F. (113° C.) and having a penetration of at least about 15 dmm at 77° F. (25° C.).”

Alternatively, one may use the roofing asphalt formulation claimed in U.S. Pat. No. 4,382,989 (the entire disclosure of which is hereby incorporated by reference into this specification) in step 14 of this process. Claim 1 of this patent describes: “1. An improved asphalt coated roofing material of the type having roofing felt coated with asphaltic coating composition wherein the improvement comprises a filled asphaltic coating composition comprising: about 40 percent to about 99 percent by weight of asphaltic composition comprising, about 52 to about 99 percent by weight of oxidized asphalt, about 1 to about 8 percent by weight of oxidized polyethylene and 0 to about 40 percent by weight of a saturant; and about 1 percent to about 60 percent by weight of stone dust.”

Alternatively, one may utilize the roofing product claimed in U.S. Pat. No. 4,554,023 (the entire disclosure of which is hereby incorporated by reference into this specification) in step 14 of this process. Claim 1 of this patent describes: “1. A roofing product including a composition comprising an asphalt and bis-stearoylamide, the bis-stearoylamide improving the weatherability of the product and constituting from about 2 to about 6% of the weight of the combination of asphalt and bis-stearoylamide.”

Alternatively, one may the asphalt composition claimed in U.S. Pat. No. 4,497,921 (the entire disclosure of which is hereby incorporated by reference into this specification) in step 14 of this process. Claim 1 of this patent describes: “1. A composition comprising asphalt, 1 to 25 weight percent based on the weight of the asphalt of oxidized polyethylene having a Brookfield viscosity at 149.degree. C. of from 100 to 40,000 centipoises, from 0.1 to 10 percent by weight based on the weight of the asphalt of sulfur, 0 to 40 percent by weight based on the weight of the asphalt of an initial viscosity modifier and, 0 to 150 percent by weight based on the weight of the asphalt of a filler.”

Alternatively, one may use the asphalt composition claimed in U.S. Pat. No. 7,678,467 (the entire disclosure of which is hereby incorporated by reference into this specification) in step 14 of the process of this invention.

In one embodiment, the asphalt used in step 14 of the process of this invention is Hunt Refining Asphalt sold by the Hunt Refining Company. This asphalt will oxidize to a penetration of 16 to 21 DMM at 77 degrees Fahrenheit and has a ring and ball softening point of 210 to 220 degrees Fahrenheit.

Other prior art roofing asphalts that may be used in step 14 of the process of this invention include the asphalt compositions disclosed in U.S. Pat. Nos. 5,047,457 (acrylate polymer modified asphalt), 5,095,055 (acid-treated polymer-modified asphalt), 5,221,703 (asphalt compositions comprised of tall oil materials), 5,254,385 (encapsulated asphalt), 5,256,710 (phenolic-type polymer modified asphalt), 5,202,638 (asphalt/O-modified polyethylene compositions), 5,331,028 (polymer modified asphalt compositions), 5,451,162 (SBS-modified asphalt), 5,516,817 (flame retarded modified asphalt), 5,638,498 (process for making rubber-modified asphalt compositions), 5,786,085 (asphaltic polyurethane foam), 5,891,224 (rubber modified asphalt), 5,938,832 (crumb rubber modified asphalt), 5,973,037 (styrene ethylene butylenes copolymer modified asphalt), 5,998,514 (random vinyl substituted aromatic conjugated diolefin polymer modified asphalt compositions), 6,031,029 (asphalt compositions), 6,036,843 (method for reducing hydrogen chloride emissions from an asphalt air blowing process), 6,037,398 (SBR-SBS asphalt roofing compositions), 6,057,390 (crosslinkable polymer modified asphalt), 6,074,469 (asphalt composition), 6,113,681 (toner modified asphalt compositions), 6,117,926 (acid-reacted polymer modified asphalt compositions), 6,228,809 (asphalt compositions), 6,399,680 (acid-reacted polymer modified asphalt compositions), 6,414,056 (asphalt compositions), 6,444,731 (modified asphalt), 6,478,951 (compatibilizer for crumb rubber modified asphalt), 6,562,118 (asphaltic compositions containing fibrous materials), 6,569,925 (accelerator-gel additive for use in the production of polymer modified asphalt), 6,583,202 (roofing membrane), 6,699,125 (self adhered modified bitumen roofing material), 6,713,539 (storage stable modified asphalt composition), 6,818,867 (modified asphalt with carrier and activator material), 6,884,831 (modified asphalt with partitioning agent), 6,972,047 (incorporation of gilsonite into asphalt compositions), 6,993,876 (asphalt roofing composite), 7,144,933 (modified asphalt compositions), 7,160,935 (tubular reactor ethylene/alkyl acrylate copolymer as polymeric modifiers for asphalt), 7,205,344 (crosslinker for modified asphalt), 7,238,048 (roofing materials having engineered coatings), 7,281,358 (roofing shingle), 7,317,045 (polyethylene modified asphalt compositions), 7,341,624 (asphalt compositions), 7,365,311 (use of zinc oxide to improve compatibility of polymer modified asphalt with phenol aldehyde resin), 7,371,794 (modified asphalt with partitioning agent), 7,374,659 (methods and systems for modifying asphalt), 7,402,619 (cross-linking composition for modified asphaltic compositions), 7,404,693 (polymer-modified asphalt compositions), 7,417,082 (modified asphalt binder material using crosslinked crumb rubber), 7,439,286 (modified asphalt compositions), 7,442,658 (impact resistant roofing shingles), 7,495,045 (use of inorganic acids with crosslinking agents in polymer modified asphalts), 7,541,059 (roofing materials having engineered coatings), 7,582,155 (asphalt nanocomposite based roofing products), 7,608,650 (bitumen/rubber compositions crosslinked with polythiomorpholines, polysulfides, or mercaptobenzimidazole), 7,642,302 (modified asphalt binders), 7,645,820 (use of zinc oxide to improve compatibility of modified asphalt crosslinked with phenol aldehyde resin), 7,678,467 (asphalt shingle coating with improved tear strength), 7,696,267 (asphalt composition containing hydrogenated conjugated diene copolymer), 7,713,345 (polyphosphate modifier for warm asphalt applications), 7,726,608 (industrial roofing systems), 7,765,763 (shingle roofing system), 7,781,503 (unsaturated polymer and phosphorus pentasulfide additives), and the like. The entire disclosure of each of these United States patents is hereby incorporated by reference into this specification.

An asphalt roofing shingle, constructed in the conventional manner, typically utilizes a petroleum based roofing asphalt which has been oxidized by blowing with air at a temperature of approximately 500 degrees Fahrenheit, to a final Ring & Ball Softening Point of between 195 degrees Fahrenheit and 215 degrees Fahrenheit. Such a softening point can be determined by ASTM standard test D 36.

The aforementioned petroleum based roofing asphalt which has been oxidized, typically has a “Needle Penetration” of between 15 deci-millimeters (DMM) and 23 deci-millimeters (DMM) (at 77 degrees Fahrenheit). Such “Needle Penetration” can be determined by ASTM standard test D 5.

The aforementioned petroleum based roofing asphalt which has been oxidized is typically referred to in the trade as “asphalt shingle coating;” and it is often combined with a commercial filler and thereafter applied to a commercially available non-woven glass fiber roofing fabric.

In one embodiment, the asphalt used in step 14 of the process of this invention is asphalt supplied by one or more asphalt refineries. This asphalt will have a Softening Point of between 80 degrees Fahrenheit and 150 degrees Fahrenheit, a (Cleveland Open Cup) Flashpoint of between 520 degrees Fahrenheit and 620 degrees Fahrenheit and a viscosity of between 300 and 3000 centipoises. This asphalt will oxidize to a penetration of 11 to 21 DMM at 77 degrees Fahrenheit and has a ring and ball softening point of between 200 and 250 degrees Fahrenheit.

In this embodiment, the oxidized asphalt has been optimized by the application of one or more additives and/or treatments to the asphalt or to the oxidized asphalt as previously described in order to optimize the characteristics of cost, viscosity, penetration and softening point of the oxidized asphalt as it relates to a roofing composition and the manufacture of asphalt roofing shingles; in one aspect of this embodiment, the filler particles are coated with the viscosity-reducing agents as described elsewhere in this specification. Such asphalt additives and/or treatments might include waxes, oils, oxidized or un-oxidized polyethylene, bis-stearoylamide wax, blowing catalysts, anti-strip additives or one or more of a wide range of other additives and modifiers previously described in the prior art.

In one preferred embodiment, the asphalt used in the process of this invention (see step 14) is comprised of two or more blended oxidized asphalts.

In one preferred embodiment, the asphalt used in the process of this invention (see step 14) is replaced, in whole and/or part, with one or more asphalt modifiers. These asphalt modifiers are well known to those skilled in the art. Reference may be had, e.g., to U.S. Pat. Nos. 4,560,414 (modifier for paving asphalt), 5,393,819 (asphalt modifier), 5,399,598 (asphalt composition), 5,990,206 (asphalt modifier composition and asphalt composition), 6,503,968 (asphalt modifier of styrene-butadiene-styrene block copolymer), and the like. The entire disclosure of each of these United States patents is hereby incorporated by reference into this specification.

Reference also may be had, e.g., to Chapter 8 (“Polymeric Modifiers for Improved Performance of Asphaltic Mixtures”) of Arthur M. Usmani's “Asphalt Science and Technology,” Marcel Dekker, Inc., New York, N.Y. 1997).

In general, the asphalt binder that is used in the process of this invention (see step 14) may be replaced, in whole or in part, by one or more of the binder materials that are known to have been used in roofing shingles. Reference may be had, e.g., to U.S. Pat. Nos. 3,848,384 (composition shingle), 3,931,440 (roofing shingle using an asphalt composition), 4,273,685 (rubber modified asphalt compositions), 4,392,371 (asphalt compositions modified with organo-silane compounds), 4,301,851 (chemically modified asphalt compositions), 4,316,829 (modified asphalt composition), 4,322,928 (asphalt composition shingles), 4,332,705 (asphalt compositions modified with a rubbery polymer), 4,335,186 (chemically modified asphalt compositions), 4,338,231 (modified asphalt compositions), 4,349,388 (asphalt compositions modified with organo-silane compounds), 4,378,447 (cationic amine modified asphalt compositions), 4,384,073 (cationic alkenyl azabenzene chemically modified asphalts), 4,384,074 (cationic chemically modified asphalts), 4,394,481 (cationic acrylamide and rubber modified asphalts), 4,394,482 (modified asphalt composition), 4,404,316 (chemically modified asphalt compositions), 4,548,650 (diatomite-modified asphalt), 4,677,146 (modified asphalt compositions comprising a nitrogen derivative of an esterified copolymer), 4,833,184 (acrylate-modified asphalt), 4,850,844 (apparatus for making tapered plastic shingles), 4,868,233 (polyethylene modified asphalts), 5,019,610 (polymer-modified asphalts and asphalt emulsions), 5,059,300 (asphalts modified by solvent de-asphalted bottoms and phosphoric acid), 5,095,055 (acid treated polymer modified asphalts), 5,256,710 (phenolic-type polymer modified asphalts), 5,290,355 (roofing shingle composition), 5,331,028 (polymer modified asphalt compositions), 5,364,894 (emulsification of asphalt and modified asphalt with primary emulsifier polymers comprised of acrylic acid type monomers), 5,451,621 (SBS-modified asphalt-based material), 5,460,852 (polymer modified asphalt coating), 5,660,014 (composite shingle having shading zones in different planes), 5,571,596 (advanced composite roofing shingle), 5,851,276 (crumb rubber modified asphalt), 5,866,211 (rubber modified asphalt), 5,891,224 (rubber modified asphalt), 5,973,037 (styrene ethylene butylenes styrene copolymer rubber modified asphalt), 6,150,439 (polymer modified asphalt), 6,444,731 (modified asphalt), 6,569,925 (polymer modified asphalt), 6,713,539 (storage-stable modified asphalt compositions), 6,818,687 (modified asphalt with carrier and activator material), 6,884,431 (modified asphalt with partitioning agent), and the like. The entire disclosure of each of these United States patents is hereby incorporated by reference into this specification.

### Determining the Baseline Value of the Filler/Asphalt Mixture

In one embodiment, the “baseline viscosity values” of particular combinations of filler and asphalt are first determined in order to be able to determine what advantage, if any, modification of the filler and/or the asphalt might have.

In order to determine such “baseline value,” the limestone filler that has been chosen to use in step 12 of the process, and the asphalt that has been chosen to use in step 14 of the process, the process, are then heated to a temperature of from about 250 to about 350 degrees Fahrenheit for from about 60 to 240 minutes in order to insure stable, uniform temperatures in both the filler material and the asphalt material that are preferably substantially identical to each other.

The limestone filler and the asphalt are preferably separately heated to a temperature that is substantially identical. It is preferred that the temperature to which each of these materials are heated to be within about 5 degrees of each other.

The temperature selected to which the limestone filler and the asphalt each is heated is one that will reduce the viscosity of the asphalt sufficiently that will assure ease of uniform mixing of the filler material into the asphalt without needless fumes or odors and with minimal risk of splashing the hot asphalt out of the container. As any temperature gradient existing in the asphalt or the filler material might hamper uniform mixing of the sample, both materials must be heated or maintained at the desired temperature for a sufficient time to assure uniformity throughout the sample. In general, the materials must be separately heated at least one hour to achieve a uniformity of temperature.

In the embodiment depicted in FIG. 1, the filler material and the asphalt material are separately heated in, e.g., steps 16 and 18. Thus, e.g., such filler material and such asphalt material may be heated in separate containers in the same oven to substantially the same temperature.

In the experiments described in the Examples of this specification, both the asphalt and the limestone filler material were heated to a temperature of 350 degrees Fahrenheit for 3 hours in order to obtain a stable and uniform temperature for both of these materials.

Thereafter, and in step 20 of the process, the heated filler material is mixed with the heated asphalt material. One may use a suitable apparatus to effectuate such mixing.

In one embodiment, the mixing apparatus is at the temperature of the heated asphalt and the heated filler

In one embodiment, a multiplicity of wooden hand mixers (such as wooden spatulas) are used to mix the filler material with the asphalt.

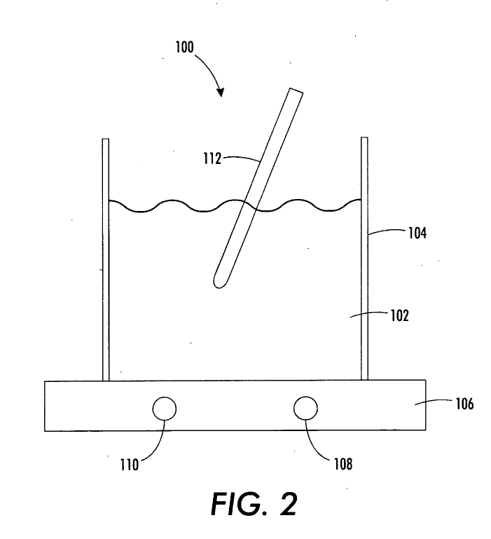

Regardless of how the mixing is effectuated, mixing should be continued until a homogeneous mixture is obtained. The apparatus 100 (see FIG. 2) may be used for mixing step 20.

Referring to FIG. 2, the heated asphalt 102 is preferably charged into a metal container 104. The container 104 is heated by, e.g., a hot plate 106 with a temperature control switch 108 and an on-off switch 110. A sufficient amount of the heated asphalt 102 is charged to the container 104 to provide a composition with the desired loading of filler. In the experiments described in the Examples of this specification, sufficient amounts of filler and asphalt were charged to provide a filler loading weight of 65 percent (by combined weight of asphalt and filler). One may use higher of lower filler loadings. In one embodiment, the filler loading is from about 71 to about 75 weight percent of filler; in this embodiment, the filler/asphalt mixture at a temperature of about 425 to about 475 degrees Fahrenheit is from about 2,000 to about 4,500 centipoise. In another embodiment, the filler loading is from about 76 to about 80 weight percent; in this latter embodiment, the filler/asphalt mixture at a temperature of about 425 to about 475 degrees Fahrenheit is from about 2,000 to about 4,500 centipoise

Once the heated asphalt 102 has been charged into the metal container, it is mixed (by, e.g., wooden spatula) while being heated by hot plate 106 so that its viscosity is maintained (preferably at from about 2000 to about 4500 centipoise) and its temperature is maintained (preferably at from about 350 to about 400 degrees Fahrenheit). While the asphalt is being thus heated and stirred, the heated limestone is added with continued stirring. After such addition, the mixing is then continued for from about 2-3 minutes, by hand, and the hot mixture is then transferred to a thermal cell adapted to heat such mixture while determining its viscosity at various temperatures in step 22.

One preferred thermal cell assembly that may be used in step 22 is the Brookfieled DV-II+Brookfield Viscometer equipped with a thermocell and an SC4-27D spindle; this device is manufactured by the Brookfield Engineering Laboratories company of 11 Commerce Boulevard, Middleboro, Mass. 02346. This device has a built-in temperature probe, and it is capable of displaying the viscosity of the hot mixture as its temperature is varied. In applicants' process, it is preferred to use this device is used with a number 27 spindle in accordance with ASTM D 4402.

### Choosing the Candidate Viscosity Reducing Agent

Referring again to FIG. 1, and in step 24 thereof, candidate viscosity reducing agents are chosen.

In one preferred embodiment, naphthenic mineral oil may advantageously be used in step 24 of the process of the invention to provide a coated mineral filler that is then mixed with asphalt.

Naphthenic mineral oils contain a significant proportion of naphthenic compounds, and they are well known to those skilled in the art. Reference may be had to the following United States patents which refer to “napthenic mineral oil” in their claims: 3,980,448 (organic compounds as fuel additives), 4,101,429 (lubricant compositions), 4,180,466 (method of lubrication of a controlled-slip differential), 4,324,453 (filling material for electrical and light waveguide communications cables), 4,374,168 (metalworking lubrication), 4,428,850 (low foaming lubricating oil compositions), 4,510,062 (refrigeration oil composition), 4,676,917 (railway diesel crankcase lubricant), 4,720,350 (oxidation and corrosion inhibiting additives for railway diesel crankcase lubricants), 4,793,939 (lubricating oil composition containing a polyalkylene oxide additive), 4,781,846 (additives for aqueous lubricant), 5,460,741 (lubricating oil composition), 5,547,596 (lubricant composition for limited slip differential of a car), 5,658,886 (lubricating oil composition), 6,063,447 (process for treating the surface of metal parts), 6,245,723 (cooling lubricant emulsion), 6,482,780 (grease composition for rolling bearing), 6,736,991 (refrigeration lubricant for hydrofluorocarbon refrigerants), and the like. The entire disclosure of each of these United States patents is hereby incorporated by reference into this specification.

In one embodiment, the additive used to coat the limestone is naphthenic mineral oil, the coated limestone is present at a loading of at least 71 weight percent in the filler/asphalt mixture, and the viscosity of such mixture at a temperature of from 425 to about 475 degrees Fahrenheit is from about 2,000 to about 4500 centipoise. In one aspect of this embodiment, the particle size distribution of the coated limestone material is such that it contains less than about 5 weight percent of the fines that are smaller than about 10 microns.

Similar results are obtained under substantially the same conditions when the naphthenic mineral oil is replaced, in whole or in part, petroleum based oils and/or animal oil (lard, e.g.) and/or naturally occurring oils (such as plant oils). Thus, by way of illustration, one may use soy oil, corn oil, sunflower oil, palm oil, and the like.

In one embodiment, the naphthenic mineral oil is replaced by a lubricant that lubricates the surfaces of the limestone particles.

In one embodiment, the naphthenic mineral oil is replaced, in whole or in part, by an additive that creates a water-impervious coating on the particles of limestone. In general, such coating is from about 10 to about 200 microns thick; and it preferably increases the lubricity of the surfaces of the coated particle.

In one embodiment, from about 0.1 to about 5.0 percent of the naphthenic mineral oil is coated onto the limestone particles. In one aspect of this embodiment, from about 0.2 to about 1.0 weight percent of such additive is used.

In one embodiment, only those limestone particles that are smaller than 74 microns are coated with the additives. In another embodiment, only those limestone particles that are larger than 74 microns are coated with the additives. In another embodiment, particles smaller than 74 microns are treated with one additive, and particles larger than 74 microns are treated with another additive. In yet another embodiment, all of the particles in the limestone are coated with the same additive.

In another embodiment, the viscosity reducing additive either a dispersing agent and/or an electrolyte as those terms are defined in U.S. Pat. No. 4,282,006, the entire disclosure of which is hereby incorporated by reference into this specification.

Thus, e.g., the dispersing agent may be present at a weight of from about 0.05 to about 2 weight percent. Thus, e.g., the dispersing agent may be an organic or inorganic surfactant and characterized in that said surfactant is an anionic surfactant. Thus, e.g., the dispersing agent may be an anionic surfactant selected from the group consisting of (i) 2-ethylhexyl polyphosphoric ester acid anhydride and its potassium salt, (ii) complex organic polyphosphoric ester acid anhydride and its potassium salt, (iii) alkyl mononaphthalene sulfonic acid and its sodium and ammonium salts, and (iv) mixtures thereof.

In one embodiment, the viscosity reducing additive that is used in such step 24 is a polyamine such as, e.g., epoxylated polyamine.

Some preferred polyamines are disclosed in U.S. Pat. No. 4,430,127, the entire disclosure of which is hereby incorporated by reference into this specification, wherein it is disclosed that: “The art discloses several antistripping agents which are useful as additives in bitumens and asphalts. For example, U.S. Pat. No. 2,759,839 to Crews et al. discloses antistripping agents having the formula: ##STR1## where R is an alkyl group of at least about 8 carbon atoms, R′ is an ethylene or propylene radical, and x and y are integers, the sum of which is not greater than about 8.” U.S. Pat. No. 4,430,127 also discloses that “U.S. Pat. No. 3,615,797 discloses bitumen additives which improve the adhesion properties of the bitumen. These additives have the formula: ##STR2## wherein R is an alkyl or alkenyl radical of 8 to 22 carbon atoms; a, b, c and d are integers from 1 to 7 and the sum of a+b+c+d is from 4 to 10; A is an organic or inorganic acid and m is 0 or an integer from 1 to 3, its acid salts and mixtures thereof.” U.S. Pat. No. 4,430,127 also discloses that: “Organic compounds which are structurally similar to those disclosed in U.S. Pat. Nos. 2,759,839 and 3,615,797 but which have utilities other than as antistripping additives for bitumens and asphalts are disclosed in the following patents: U.S. Pat. No. 2,767,214 to Bersworth discloses polyhydroxy polyalkylene polyamines which are useful as surface active agents, detergents, wetting agents and as intermediates in the production of soap-like amino compounds. The polyhydroxy polyalkylene polyamines have the general structural formula: ##STR3## wherein Y is a bivalent alkylene chain containing from 2 to 3 carbon atoms; X is a bivalent alkylene radical of from 4 to 12 carbon atoms which may be interrupted with ether oxygen atoms; Z is a bivalent alkylene radical of from 2 to 6 carbon atoms which may be either branched or straight chained; and A is a member of the group consisting of hydrogen and one of the substituent groups consisting of methyl, ethyl, n-propyl, isopropyl and butyl. U.S. Pat. No. 2,901,461 to Auerbach et al. discloses hydroxyalkyl alkylene polyamines containing at least one hydroxyalkyl group and at least three amino hydrogen atoms per molecule which are useful as hardeners for polyepoxy compounds and which have the general formula: ##STR4## wherein x is an integer from zero to 3, n is an integer from 2 to 6, R in each instance is a monovalent substituent being either hydrogen or a hydroxyalkyl group, and the number of instances per molecule where R represents a hydroxyalkyl group being at least one, but less than x+2. U.S. Pat. No. 3,200,155 discloses compounds having the formula: ##STR5## wherein R.sub.1, R.sub.2, R.sub.3, R.sub.4 and R.sub.5 are selected from the group consisting of hydrogen, HOCH.sub.2 CH.sub.2-, ##STR6## wherein R.sub.6 is one of hydrogen, methyl or ethyl in at least one occurrence and another one of hydrogen, methyl and ethyl in the remainder of occurrences, x is a small integer, and at least one of R.sub.1, R.sub.2, R.sub.3, R.sub.4 and R.sub.5 is one of the aforedefined groups other than hydrogen. The disclosed compounds are useful as chemical intermediates and cross-linking agents.” Such U.S. Pat. No. 4,430,127 also discloses that: “ . . . unexpectedly high adhesion between aggregate and bitumen and improvements in the tensile strength of paving compositions are achieved when epoxylated polyamines wherein at least two of the amino nitrogen atoms are separated by six carbon atoms are added to the bitumen or asphalt as anti-stripping agents.” The entire disclosure of each of the United States patents mentioned in U.S. Pat. No. 4,430,127 is hereby incorporated by reference into this specification.

In one embodiment, one may use one or more of the asphalt additives sold by the “ArrMaz Custom Chemicals” company of 4800 State Road 60 East, Mulberry, Fla. 33860 in such step 24. These additives include, e.g., “AD-here HP Plus,” “ACRA 500,” “AD-here LOF 65-00 LS,”AD-here 64-10,” tallow diamine, amido amines and salts, aminoester from tall oil fatty acid and triethanolamine, and the like.

In one embodiment, one may use silicone oils sold by Goldschmidt Chemical of Hopewell, Va. under the names of “Tegosivin HL100,” “Tegosivin HL 15M7,” and “Tegopren 6800” and “Tegopren 5840” in such step 24.

In one embodiment, one may use in such step 24 fatty acid amines such as lauryl amine and stearyl amine; amido amine anti-strip agents and/or salts thereof; unsaturated carboxylic acid anti-strip agents; alpha-olefin copolymers; polyetheramine fatty acid salts; fatty acids such as, e.g., oleic acid and stearic acid; naphthenic oils such as that sold by the Cross Oil company as “HS-500;” alkylene diamines; dialkyl amines; the aminoester products produced by the reaction of tall oil fatty acid and triethanolamine that are described in U.S. Pat. No. 4,806,166, the entire disclosure of which is hereby incorporated by reference into this specification; polyamine anti-strip agents such as, “PAVEBOND LITE” by the Morton International company, an anti-strip agent sold by the Arizona Chemical company as “100NS.”

The aforementioned listing is merely illustrative, and many other agents may be suitable for use in step 24 of the process of the invention. In one embodiment, a candidate viscosity reducing agent is chosen to coat the limestone particles that, when incorporated into the asphalt being used reduces the viscosity of such asphalt. Thus, e.g., stearic acid when incorporated into an asphalt shingle coating produced by the Hunt refining company reduces the viscosity of such asphalt, and when the same amount of stearic acid is coated onto the limestone particles but is not used to modify the asphalt, such stearic acid also reduces the viscosity of the coated filler/asphalt mixture.

Once the candidate viscosity reducing agent is chosen in step 24, it is sprayed onto the filler particles in step 26.

Spraying the Additive onto the Filler Particles

In step 26, the additive, which is preferably in liquid form, is sprayed onto the filler particles. If it is not in a liquid phase, it is converted to a liquid phase prior to the time it is sprayed onto the filler material.

The additive may be sprayed by conventional methods such as, e.g., those described on pages 18-58 to 18-65 of Robert H. Perry et al.'s “Chemical Engineers Handbook,” Fifth Edition (McGraw Hill Book Company, New York, N.Y., 1973).

Thus, e.g., and as is disclosed in the Chemical Engineers Handbook, one may use spray nozzles such as, e.g., the nozzles illustrated in FIG. 18-112 and Table 18-21 of such handbook.

One may use the nebulizer described in U.S. Pat. No. 6,705,312, the entire disclosure of which is hereby incorporated by reference into this specification. This patent describes a device that has a main body containing a vibrating element, electronic circuitry, and battery for powering the circuitry and the vibrating element. An atomiser is provided on top of the main body, and is suitably coupled to the electronic circuitry and the vibrating element to allow for atomisation of liquid.

One may use the spraying process described in U.S. Pat. No. 6,966,610, the entire disclosure of which is hereby incorporated by reference into this specification. As is disclosed in such patent, “the spraying may be carried out by the use of a spray gun for example Hot Shot Adhesive gun available from Sericol Limited of the United Kingdom which uses compressed air at up to 10 bar and preferably from 5 to 7 bar . . . . Power HB 600 spray melt, a spray gun available from Power Adhesives Limited of the United Kingdom is also suitable for use in the present invention. The gun uses compressed air at up to 8 bar heated to 70 to 250° C. . . . . The spraying may conveniently be carried out using a hand held spray gun provided with an electrically heated compartment for the adhesive and means for supplying air under pressure to the molten adhesive to assist the spraying. Instead of the gun being hand held the adhesive may be automatically applied using an automatic spray gun or other applicators.”

One may use a nebulizer such as, e.g., the ultrasonic nebulizer described in U.S. Pat. No. 7,673,812, the entire disclosure of which is hereby incorporated by reference into this specification. Claim 1 of this patent describes: “1. A portable ultrasonic nebulizer apparatus for automatically adjusting an operation frequency of the apparatus corresponding to a resonant frequency, comprising: a power supply for supplying power; vibrating element to vibrate a liquid to form an aerosol of fine droplets; a variable oscillator for providing a plurality of frequencies to the vibrating element so as to let the vibrating element vibrates at the plurality of frequencies; a step-up converter electrically connected with the variable oscillator for converting an input voltage to a boosted voltage to the vibrating element; a current detecting element positioned between the power supply and the vibrating element for detecting a plurality of electrical current values passing before the vibrating element, the value being respectively related to each of the plurality of frequencies; and a microprocessor for receiving the plurality of electrical current values related to each of the plurality of frequencies so as to determine the resonant frequency at which the electrical current is a maximum value and adjusting the operation frequency of the vibrating element provided by the variable oscillator corresponding to the resonant frequency.”

One may spray the additive onto the limestone filler by the process described in U.S. Pat. No. 7,611,753, the entire disclosure of which is hereby incorporated by reference into this specification. Claim 1 of this patent discloses: “1. A process comprising impregnating a porous mineral substrate with a liquid impregnating agent, wherein the impregnating comprises spraying the liquid impregnating agent and a gas from a gas-supported spraying assembly; and the liquid impregnating agent is sprayed from the gas-supported spraying assembly at a pressure of at most 2 bar gauge, wherein the gas-supported spraying assembly comprises a nozzle system comprising one or more nozzles; the liquid impregnating agent and the gas are fed into each of the one or more nozzles at a pressure of at most 2 bar gauge; and the gas atomizes the liquid impregnating agent in each of the one or more nozzles, wherein the liquid impregnating agent is substantially free of solvent.”

One may deposit the additive onto the limestone filler by means of the ultrasonic fog generator described in U.S. Pat. No. 7,810,742, the entire disclosure of which is hereby incorporated by reference into this specification. Claim 1 of this patent describes: “1. An ultrasonic fog generator comprising: a container comprising therein an ultrasonic nebulizer and a liquid, said ultrasonic nebulizer operative to vibrate at very high frequencies and thereby break down the liquid into a fog comprising tiny vapor particles, said container having an exit opening for said fog to pass therethrough; a driver and a driving fluid, said driver being operative to cause said driving fluid to flow past the exit opening and draw out said fog through the exit opening without said driving fluid substantially entering said container, wherein said driver is positioned facing a closed rear face of said container and said exit opening is positioned on a front face of said container opposite said rear face, wherein said front face of said container comprises a wall extending from side faces of said container, and said exit opening is formed through said wall.”

One may deposit the additive onto the limestone filler by means of the plasma spraying device disclosed in published United States patent application 20080057212, the entire disclosure of which is hereby incorporated by reference into this specification. Claim 1 of this published patent application describes: “1. Plasma spraying device for spraying a coating (2) onto a substrate (3) by a thermal spray process, said plasma spraying device including a plasma torch (4) for heating up a plasma gas (5) in a heating zone (6), wherein the plasma torch (4) includes a nozzle body (7) for forming a plasma gas stream (8), said plasma torch (4) having an aperture (9) running along a central longitudinal axis (10) through said nozzle body (7), which aperture (9) has an convergent section (11) with an inlet (12) for the plasma gas (5), a throat section (13) including a minimum cross-sectional area of the aperture, and a divergent section (14) with an outlet (15) for the plasma gas stream (8), wherein an introducing duct (16) is provided for introducing a liquid precursor (17) into the plasma gas stream (8), characterized in that a penetration means (18, 161, 181, 182) is provided to penetrate the liquid precursor (17) inside the plasma gas stream (8).”

One may deposit such additive onto the limestone filler by means of the heated nebulizer device disclosed in published United States patent application 20100258114, the entire disclosure of which is hereby incorporated by reference into this specification. Claim 1 of this published patent application describes: “1. A nebulizer assembly comprising: a reservoir for containing a liquid; a nebulizer for producing an aerosolized gas using the liquid; an aerosolized gas outlet coupled to the nebulizer to pass the aerosolized gas; and a heating chamber disposed around an exterior of the reservoir, wherein the heating chamber includes a heating fluid inlet in fluid communication with the heating chamber for providing heating fluid to the heating chamber and a heating fluid outlet in fluid communication with the heating chamber for discharging the heating fluid from the heating chamber.”

In one embodiment, the additive is heated to a temperature greater than ambient prior to the time it is sprayed onto the filler material. In another embodiment, the filler material is heated a temperature greater than ambient prior to the time the additive is sprayed onto it. In either case, it is preferred to agitate the filler during spraying in order to expose as many filler surfaces as possible to the spray.

Referring to FIG. 1, once the coated filler is produced in claim 26, it is conveyed via line 28 to step 16 wherein the coated filler is heated. Then it is mixed with the heated asphalt in step 20, and the heated asphalt/filler mixture is then tested in step 22 to determine its viscosity.

Production of Shingles with Certain Heated Asphalt/Filler Mixtures

In one embodiment, heated asphalt/filler mixtures that have suitable viscosities may be used to prepare one or more roofing shingles in step 30.

An asphalt roofing shingle, constructed in the conventional manner, typically utilizes a petroleum based roofing asphalt which has been oxidized by blowing with air at a temperature of approximately 500 degrees Fahrenheit, to a final Ring & Ball Softening Point of between 195 degrees Fahrenheit and 215 degrees Fahrenheit. Such a softening point can be determined by ASTM standard test D 36.

Such petroleum based roofing asphalt which has been oxidized typically has a “Needle Penetration” of between 16 decimillimeters and 23 decimillimeters (at 77 degrees Fahrenheit). Such “Needle Penetration” can be determined by ASTM standard test D 5.

The petroleum based roofing asphalt which has been oxidized is typically referred to in the trade as “asphalt shingle coating;” and it is often combined with a commercial filler and thereafter applied to a commercially available glass roofing fabric.

By way of illustration, one may use a commercially available bonded non-woven glass roofing fabric with a dry weight of approximately 92-95 grams/square meter, consisting of chemically sized individual “E” Glass filaments of 15.25-16.5 microns in diameter (“M” fiber) and from 0.75-1.25 inches in length, which are randomly oriented and bonded with a modified urea-formaldehyde resin binder, which has been applied to a level of 20 percent (dry weight). The fabric is often referred to in the art as a “glass roofing mat.”

The glass roofing mat is typically coated on each side and saturated with a roofing asphalt compound consisting of the aforementioned asphalt shingle coating that preferably contains at least 65 percent of a mineral filler such as limestone or stone dust; such a composition is typically referred to in the trade as a “filled asphalt coating.” In one preferred embodiment, the mineral filler used is a coated mineral filler of a certain particle size, such as, e.g., the mineral fillers described elsewhere in this specification.

The filled asphalt coating typically has a viscosity of between 2000 centipoise and 4500 centipoise when applied to the glass roofing mat at a temperature of between 425 degrees Fahrenheit and 475 degrees Fahrenheit. Such viscosity can be determined by, e.g., ASTM standard test D 4402. It is preferred to utilize a process line speed that assures complete saturation of the glass roofing mat.

The fully saturated glass roofing mat may be referred to as “the warm sheet.” Roofing granules are typically applied to the top surface of the warm sheet by gravity feed, and the granules are roll pressed into the sheet with a roll pressure of between 10 pounds per square inch and 15 pounds per square inch. The finished sheet is allowed to cool to room temperature, and then it is cut into various patterns representing the types of shingles to be sold.

### The Advantages of a Reduced Viscosity Asphalt/Filler Material

The use of this embodiment of the invention allows manufacturers of roofing shingles substantially more flexibility in modifying their processes than was allowed with prior art filled asphalt coatings.

Thus, e.g., the roofing manufacturer can reduce the viscosity of the filled asphalt coating and thereby create the opportunity for compensatory adjustments in the manufacturing process to be made, specifically, increased line speed because of the improved ability to saturate the glass fabric more effectively.

Thus, e.g., the manufacturer may reduce the operating temperature required to process the filled asphalt coating and thus reduce the amount of energy consumed by the process. In these days of increased energy costs, this is a substantial advantage. Without wishing to be bound to any particular theory, applicants believe that the use of applicants' preferred filler compositions produces filled asphalt coatings with reduced viscosity and thus provides the opportunity to reduce the filled asphalt coating process temperature by at least 5 degrees Fahrenheit while maintaining the same viscosity experienced with prior art filled asphalt compositions.

The filled asphalt coating typically used in the manufacture of roofing shingles typically has a viscosity of between 2000 centipoise and 4500 centipoise and is applied to the glass fabric at a temperature of between 425 degrees Fahrenheit and 475 degrees Fahrenheit, at a particular process line speed, to assure complete saturation of the glass roofing mat. One can modify a conventional prior art process with applicants' composition by either reducing the viscosity of the filled asphalt coating and/or reducing the coating temperature used to apply said coating to the glass roofing mat.

Alternatively, when the viscosity of the filled asphalt coating increases, the roofing manufacturer may maintain the line speed but increase the process temperature. This alternative, although effective, requires more energy and this increases the cost of producing the roofing shingles. Furthermore, the use of a higher process temperature often necessitates the use of asphalts with higher flash points; these asphalts are relatively expensive.

Applicants' composition allows one to run a manufacturing process at lower coating temperatures and, thus, allows one to utilize lower quality asphalts and/or asphalts with lower flash points, thus affording the roofing manufacturer substantially more flexibility in securing acceptable and lower cost asphalts.

With prior art shingle manufacturing processes, and in order to avoid risk of a fire in the oxidation and roofing process, the petroleum based asphalt selected to be used to produce the asphalt shingle coating typically has a flash point of at least 550 degrees Fahrenheit. In one embodiment, with the use of applicants' composition, the asphalt used in such composition can have a flash point as low as 540 degrees Fahrenheit and, more preferably, as low as 530 degrees Fahrenheit.

The use of applicants' composition allows one to increase the “filler loading” in the filled asphalt coating. The inorganic filler used in such compositions is typically much cheaper than the asphalt component; and an increase in the “filler loading” with a concomitant decrease in the “asphalt loading” substantially reduces the cost of producing such filled asphalt coating while not adversely affecting the properties of the roofing shingles made from such coating.

The Manufacture of Asphalt Shingles with Reduced Asphalt Contents.

The manufacture of asphalt shingles is well described in the patent literature. Reference may be had, e.g., to U.S. Pat. Nos. 4,269,450 (asphalt shingle remover), 4,468,430 (asphalt shingle with glass fiber mat), 4,817,358 (asphalt shingle with foamed asphalt layer u tabs), 6,895,724 (laminated hip and ridge asphalt shingle), and 6,926,669 (methods and apparatus for recycling asphalt single materials). The entire disclosure of each of these United States patents is hereby incorporated by reference into this specification.

U.S. Pat. No. 4,328,147, the entire disclosure of which is hereby incorporated by reference into this specification, describes the “roofing felt” onto which the filled asphalt composition is applied. Such patent discloses that “Roofing felt from a continuous roll is coated with the asphalt formulation at about 400° F. Roofing granules, a colored ceramic stone baked onto stone granules, are pressed into the coating. The shingle color becomes the color of the granules. This coated felt roll is cooled and the shingles, with desired cut-outs, are continuously cut from the continuous shingle roll. Typically, the roll is three feet wide and shingles are one by three feet with cut-outs.”

U.S. Pat. No. 4,328,147 also discloses that “In recent years roofing felt material has been changed from cellulose to glass fibers. The new glass fiber shingle is thinner and more flexible than the old cellulose felt shingle. Therefore, the coating must have better flexibility properties, particularly at cold temperatures. If this is not the case, flexing at cold temperatures causes surface cracking in the shingles. The cracks are failure sites and points for future leaks to develop.”

“ASTM International” (of 100 Barr Harbor Drive, P.O. Box C700, West Conshohocken, Pa. 19428) has developed a “Standard Specification for Asphalt Shingles Made from Glass Felt and Surfaced with Mineral Granules,” D 3462-05. This standard has been widely accepted in the roofing industry as an authoritative criterion for the acceptability of fiberglass shingles.

Section 6 of ASTM D 3462-05 deals with “Dimensions, Masses and Permissible Variations.” Section 6.3 of this standard specifies that “The shingles shall confirm to the masses prescribed in Table 2.”

Table 2 of ASTM D 3462-05 appears on page 3 of such Standard, and it is entitled “Masses of Asphalt Shingles Made from Glass Felt.” hi the last two lines of such table, it is specified that “Mass percent of mineral matter passing a No. 70 (212-μm) sieve based on the total asphalt and mineral matter passing the No. 70 (212-μm) sieve” shall be no greater than 70 percent.”

The specification that the shingle contain no more than about 70 weight percent of mineral filler with a particle size less than 212 microns was developed because of a belief that shingles containing more than this much “fine filler” would crack prematurely and/or fail the tear standard set forth in ASTM standard test D 3462-05 (and its predecessor ASTM standard test D 3462-03). As a result of this specification, and the widespread belief that asphalt shingles containing more than 70 weight percent of “fine filler” are unacceptable, many shingle manufacturers continue to make shingles comprised of from about 65 to about 69 weight percent of fine filler and from about 35 to about 31 weight percent of asphalt.

There is a widespread belief in the roofing industry that “excess mineral filler” with a particle size less than about 212 microns tends to remove essential oils from the asphalt in the roofing product and, consequently, cause cracking and premature failure of the shingle. This proposed failure mechanism is believed to be similar to the mechanism by which roofing shingles are believed to fail due to exposure to the sun. The asphalt component of roofing shingles degrades when subjected to heat, thereby releasing essential oils and weakening the bond between the asphalt and the roofing granules. As is disclosed on pages 7-8 of Mike Guertin's “Roofing with Asphalt Shingles” (The Taunton Press, Inc., Newtown, Conn., 2002), “All roof shingles will eventually degrade and fail. Except in cases of extreme weather conditions or events, the longevity of a roof is directly related to the quality of the asphalt and the strength of the heat from the sun. Heat robs asphalt of its oil, causing the shingle to become brittle. Brittle shingles crack and lose their protective granule surface coating, and the degradation process accelerates. When shingles lose patches of their granular surfacing, called spalling or blistering, the countdown to replacement should quicken. The exposed asphalt coating will deteriorate even more rapidly and precipitate further granule loss, which quickly leads to leaks.”

Even with “fine mineral filler” compositions less than about 70 percent, many of the asphalt shingles made today fail prior to the time their warranty period expires. Thus, e.g., many shingles that are warranted for 20, 30, or even 40 years fail after no more than about 15 years of use.

It is an object of one embodiment of this invention to make a roofing shingle that has durable mechanical properties and will maintain sufficient mechanical properties for a substantial period of time.

It is another object of this embodiment of the invention to provide a roofing composition that, when made into a roofing shingle by a specified process, will produce a shingle that has durable mechanical properties and that will maintain these properties sufficiently for a substantial period of time.

It is yet another object of this embodiment invention to provide a mineral filler composition that, when mixed with a specified amount of asphalt, will produce a roofing composition that, when made into a roofing shingle by a specified process, will produce a shingle that has durable mechanical properties and that will maintain these properties sufficiently for a substantial period of time.

On pages 4, 5, and 6 of this specification, claims 33, 34, and 35 of published U.S. patent application are presented, and these describe shingles comprised of an asphalt/filler mixture containing from 71 to 75 weight percent of filler. In one embodiment, the embodiments described in such claims 33, 34, and 35 are modified so that the asphalt/filler mixture contains from 76 to 80 percent of filler; in these embodiment, the same claimed properties are obtained.

In one embodiment of the invention, there is provided a composition comprised of 71 to 80 weight percent of mineral filler material with a particle size less than 212 microns and 20 to about 29 weight percent of asphalt. When the composition is incorporated into a glass felt mat with a density of from about 1.8 to about 1.9 pounds per 100 square feet and made into a single-layer roofing shingle, the shingle, after having been subjected to at least 10 cycles of Cycle A of ASTM standard test D 4798-04, has a tear resistance of at least 1,700 grams.

### Manufacture of Roofing Shingles

A typical roofing shingle 10, that it is the subject of much of the disclosure of this case, is depicted in FIG. 1 of published United States patent application, 2007/0261337, the entire disclosure of which is hereby incorporated by reference into this specification. Such FIG. 1 is a schematic sectional view of a typical roofing shingle 10. This shingle 10 is preferably constructed in layers, each serving a particular function.

Referring to such FIG. 1, the backbone of the shingle 10 is base material 12 that, in one preferred embodiment, in comprised of glass felt material. As is disclosed on pages 5-6 of Mike Guertin's “Roofing with Asphalt Shingles” (The Taunton Press, Inc., Newtown, Conn., 2002), “The base material gives shingles strength to resist tearing during handling, installation, and in windy conditions. Asphalt shingles have a base of either organic felt or fiberglass. Organic felt was the base for the first asphalt shingles developed in the late 1890s, but fiber-glass-based singles, introduced around 1960, are lighter and less expensive to manufacture. By the late 1970s, fiberglass was more commonly used than organic felt.”

In one preferred embodiment, the glass felt material is similar to the material described in section 4 of ASTM D 3462-05. It is disclosed in this section, that “The glass felt shall be a thin porous sheet composed predominantly of fine glass fibers uniformly deposited in a nonwoven pattern. It is permitted to reinforce the glass felt with random or parallel-oriented glass yarns, or both, which are permitted to be gathered or twisted, bonded, or unbonded. The felt shall contain a substantially water-insoluble binding agent.”

In one embodiment, the properties of applicants' mineral filler composition, and of their mixture of asphalt and mineral filler composition, are tested by incorporating such compositions into a specified glass felt mat, making a roofing shingle from the glass felt mat impregnated with such composition, exposing said shingle to at least ten cycles of “accelerated aging” testing, and thereafter testing the shingle so aged to various ASTM tests for tear resistance, pull-through resistance, and abrasion resistance.

In one embodiment, the glass felt sheet has a density of from about 1.45 to about 2.2 pounds per 100 square feet of surface area of such glass felt sheet.

In one embodiment, described in more detail elsewhere in this specification, the glass felt sheet has a density of 1.85 pounds per 100 square feet of surface area of such glass felt sheet, a thickness of about 30 mils, and a binder content (which is preferably a modified urea-formaldehyde glass binder) of about 20 percent. In one aspect of this embodiment, this is the glass felt mat that applicants prefer to use to test their roofing compositions and the shingles made therefrom. Such a glass felt sheet is typically used in the roofing industry as a roofing mat and may be commercially obtained, e.g., from the Johns Manville Corporation of Denver, Colo. as product “Dura-Glass 7521.” Johns Manville describes this material as being “ . . . a nonwoven sheet composed of individual sized glass filaments randomly oriented and bonded together with a modified urea formaldehyde resin.”

In one embodiment, and referring again to FIG. 1 of published United States patent application 2007/0261337, the base 12 is a structural mat matrix similar to that claimed in U.S. Pat. No. 5,965,638.

In one embodiment, the base 12 is a cured non-woven fiber mat similar to that claimed in U.S. Pat. No. 6,544,911, the entire disclosure of which is hereby incorporated by reference into this specification. The preparation of the mat of U.S. Pat. No. 6,544,911 is illustrated in the examples of such patent, which are discussed in column 5 thereof. It is disclosed that “Tear test D-1922, as referenced in ASTM D-3462 (Jul. 10, 1997 version), was used to determine the tear strength of various glass fiber mats coated on both sides with a 25 mil coating of asphalt conventionally used in roofing materials. In summary, the test measures the force in grams required to tear apart the coated mat specimen using a pendulum device. Acting by gravity, the pendulum swings through an arc, tearing the specimen from a precut slit. The test specimen is held at one end by the pendulum and on the opposite end by a stationary member. The loss in energy by the pendulum is indicated by a scale and pointer, which registers the force required to tear apart the specimen. To a wet web of 25-100 mm long glass fibers, derived from drainage of a white water slurry, was added at room temperature, a standard urea/formaldehyde binder containing 1 wt. % styrene/acrylate/acrylonitrile polymer modifier (i.e. Acronal S 886 S, supplied by BASF) to provide a fiber to modified binder weight ratio of about 80:20. The web containing fibers and modified binder is then sprayed with an aqueous solution of poly(dimethylsiloxane), supplied by Chem-Trend as product RCTW B9296) to provide a polysiloxane concentration of from 0.25 to 5% with respect to UF, as noted in the following table. The resulting webs were then dried and cured at about 300° C. for a period of 10 seconds to produce cured, non-woven mats, after which the mats were coated on both sides at 215° C. with filled asphalt (comprising 32% w/w asphalt and 68% w/w limestone filler) using a two-roller coater. The styrene/butadiene latex, employed in the examples was supplied Dow Chemical Co. and the urea/formaldehyde binder was obtained from Neste Co.”

By way of further illustration, the base 12 may comprise the non-woven mat described in U.S. Pat. No. 6,737,369, the entire disclosure of which is hereby incorporated by reference into this specification.

U.S. Pat. No. 6,737,369, the disclosure of which is hereby incorporated by reference into this specification, discusses various “prior art” patents in column 1 thereof, the disclosure of each of which is also hereby incorporated by reference into this specification. Thus, e.g., U.S. Pat. No. 6,737,369 discloses that “U.S. Pat. No. 4,335,186 discloses a chemically modified asphalt composition where the asphalt is reacted with a nitrogen-containing organic compound which is capable of introducing to the asphalt functional groups that can serve as reactive sites to establish a secure chemical bond between the asphalt and reinforcing fillers, blended into the asphalt, such as glass fibers and siliceous aggregates.”

U.S. Pat. No. 6,737,369 also discloses that “U.S. Pat. No. 4,430,465 relates to an article of manufacturing comprising mat fibers, such as glass fibers, that are coated with composition comprising asphalt, an alkadiene-vinylarene copolymer, a petroleum hydrocarbon resin and a branched organic amine which is employed as an anti-stripping agent.” It should be noted that this “branched organic amine” also may be used to advantageously coat applicants' limestone powder.

FIG. 2 of published U.S. patent application 2007/0261337 is a schematic illustration of a roofing assembly 30 that illustrates certain terms commonly used with reference to shingles.

Referring to such FIG. 2, which is similar to the Figure appearing at page 9 of the Guertin book, it will be seen that the butt edge 32 is the bottom edge of the shingle, The top lap 34 is that portion of the shingle covered by the next shingle laid on top. Typically, such top lap portion is about 7 inches wide.

The headlap 36 is that portion of the top lap 34 that is covered by the next two shingle courses. The headlap 36 typically is about 2 inches wide.

The exposure 38 is that part of the shingle that is exposed to the weather. The exposure 38 typically is about 5 inches wide.

The cutouts 40 are slots of shingle material cut out of the exposure of a tabbed strip shingle. The cutouts 40 are typically from about 0.37 to about 0.5 inches wide.

The self-seal strip 42 is an adhesive strip (or dots) on the shingle that bonds the butt edge 32 to the shingle beneath when exposed to heat from the sun.

The exposure gauge notches 46 are minute cuts that some manufacturers emboss on the side edges of strip shingles to help the installer gauge the proper exposure.

The offset gauge notches 48 are minute cuts embossed by some manufacturers along the top edge of the shingles to help the installer gauge a standard 6 inch offset on three-tab shingles.

FIG. 3 of published United States patent application 2007/0261337, and in step 156 thereof, roofing shingles are prepared with coated granules disposed in mass flow silo 152.

One may use the process disclosed in U.S. Pat. No. 4,274,243, the entire disclosure of which is hereby incorporated by reference into this specification. Claim 1 of this patent describes “1. A method of forming a laminated roofing shingle comprising: (a) providing an indefinite length of asphalt-impregnated, felted material; (b) adhering a coating of mineral granules to at least one surface of said felted material; (c) cutting said material in a repeating pattern along the longitudinal dimension of said material so as to form an interleaved series of tabs of pairs of overlay members, each said tab, defined by said step of cutting, being of substantially identical shape and the lower edge of each said tab being defined by a smoothly curving negatively contoured edge; (d) making pairs of underlay members in a similar manner as above but wherein the lower edges of the underlay members are defined by a substantially continuously curving sinuous cut having a uniform periodic shape and amplitude such that each pair of underlay members thus formed are substantially identical; and (e) laminating said underlay members to said overlay members so as to form a series of shingles having substantially the same overall shape, wherein said step of laminating further includes the step of positioning said negatively contoured edge of each said tab directly over a substantially correspondingly curving portion of the lower edge of each said underlay member so as to simulate a series of alternating ridges and valleys of a portion of a tile covered roof.”

U.S. Pat. No. 4,634,622 also discloses that “Later, the industry began moving more to the use of fiberglass mats instead of the conventional organic fibrous mats or asbestos fiber mats. Because fiberglass mats are much more porous than the previously used mats, this change eliminated the need for asphalt saturant. Instead, filled asphalt previously used only for the coating layer was now used both to impregnate and to coat the mat. Thus the properties of the filled asphalt became more critical. In addition to its waterproofing and weather resistant characteristics, the filled asphalt had to contribute more to the strength of the product, providing stability against deformation at roof temperatures and withstanding stresses encountered in the manufacturing process. Also, it had to adequately resist stresses due to handling by workmen and encountered by environmental conditions such as wind loading and thermal stresses.”

U.S. Pat. No. 4,634,622 also discloses that “The filler which has been used by the industry is mineral in nature comprised, for example, of ground limestone, silica, and slate, trap rock fines, and the like, and is present in the asphalt in substantial amounts. Typically, the filler used in these conventional roofing products has a specific gravity of between about 2.5 and about 3, which is several times more dense than the asphalt which it extends or displaces (the specific gravity of asphalt is about 1.0). Thus a filler content of about 60% by weight yields a filled asphalt having a specific gravity of about 1.7.”

U.S. Pat. No. 4,634,622 also discloses that “The demand for fiber glass based asphalt roofing products has increased greatly since they were first introduced, to the point where they are now the standard product in the industry. During that time, however, their physical characteristics have remained substantially the same while their cost has risen with the rise in costs of their component elements. While it would of course be desirable to produce roofing products of at least as high quality at a lower cost, it is apparent that this goal has not been attained to any significant degree. The length of time that has passed since the introduction of fiber glass based asphalt roofing products is indicative that the problems which must be overcome in order to achieve this goal are considerable.”

One may use the process described in U.S. Pat. No. 5,411,803 to make the roofing shingle; the entire disclosure of such patent is hereby incorporated by reference into this specification. As is disclosed in such patent, “Bituminous sheet materials such as roofing shingles may be produced using the granules of the invention. Roofing shingles typically comprise materials such as felt, fiberglass, and the like. Application of a saturant or impregnant such as asphalt is essential to entirely permeate the felt or fiberglass base. Typically, applied over the impregnated base is a waterproof or water-resistant coating, such as asphaltum, upon which is then applied a surfacing of mineral granules, which completes the conventional roofing shingle.” (See column 9, lines 47-57.)

Asphalt is preferably used to making the roofing shingles. As is disclosed on page 71 of George S. Brady et al.'s Materials Handbook, Twelfth Edition (McGraw-Hill Book Company, New York, N.Y., 1986), asphalt is “a bituminous, brownish to jet-black substance, solid or semi-solid, found in various parts of the world. It consists of a mixture of hydrocarbons, is fusible and largely soluble in carbon disulfide. It is also soluble in petroleum solvents and turpentine. The melting points range from 32 to 38 degrees C. Large deposits occur in Trinidad and Venezuela. Asphalt is of animal origin, as distinct from coals of vegetable origin. Native asphalt usually contains much mineral matter; and crude Trinidad asphalt has a composition of about 47% bitumen, 28% clay, and 25% water. Artificial asphalt is a term applied to the bituminous residue from coal distillation mechanically mixed with sand or limestone.”

Asphalt is also described in the claims of various United States patents, such as, e.g., U.S. Pat. Nos. 3,617,329 (liquid asphalt), 4,328,147 (roofing asphalt formulation), 4,382,989 (roofing asphalt formulation), 4,634,622 (lightweight asphalt based building materials), 4,895,754 (oil treated mineral filler for asphalt), 5,217,530 (asphalt pavements), 5,356,664 (method of inhibiting algae growth on asphalt shingles), 5,380,552 (method of improving adhesion between roofing granules and asphalt-based roofing materials), 5,382,449 (method of using volcanic ash to maintain separation between asphalt roofing shingles), 5,511,899 (recycled waste asphalt), 5,516,573 (roofing materials having a thermoplastic adhesive interface between coating asphalt and roofing granules), 5,746,830 (pneumatic granule blender for asphalt shingles), 5,776,541 (method and apparatus for forming an irregular pattern of granules on an asphalt coated sheet), 5,795,622 (method of rotating or oscillating a flow of granules to form a pattern on an asphalt coated sheet), 6,095,082 (apparatus for applying granules to an asphalt coated sheet to form a pattern having inner and outer portions), 6,358,319 (vacuum treatment of asphalt coating), 6,358,319 (magnetic method and apparatus for depositing granules onto an asphalt-coated sheet), 6,465,058 (magnetic method for depositing granules onto an asphalt-coated sheet), and the like. The entire disclosure of each of these United States patents is hereby incorporated by reference into this specification.

### Testing of the Properties of the Shingle

Referring again to FIG. 1, after the shingle has been prepared in step 30 the properties of the shingle are determined in step 32.

In one embodiment, this novel shingle product, when tested in accordance with ASTM Standard Test D 3462-05 (“Standard Specification for Asphalt Shingles Made from Glass Felt and Surfaced with Mineral Granules”), has a tear strength of at least 1700 grams. In one aspect of this embodiment, the asphalt shingle coating used to make such shingle had a filler loading of from about 71 to about 80 percent.

Furthermore, when such novel shingle product is tested in accordance with ASTM D 4798-04 (“Standard Practice for Accelerated Weathering Test Conditions and Procedures for Bituminous Materials . . . ”), Cycle A, the time to failure exceeds at least 30 days, and, and in one embodiment, the shingle still retains enough of its mechanical properties to still pass the tear strength test. In one aspect of this embodiment, the asphalt shingle coating used to make such shingle had a filler loading of from about 71 to about 80 percent.

A related ASTM test, ASTM D 4799-00, is described in U.S. Pat. No. 6,562,119, the entire disclosure of which is hereby incorporated by reference into this specification. As is disclosed in this patent, “The above object, as well as others not specifically enumerated, are achieved by a method of improving the weathering of a bituminous coating according to the invention. The method comprises adding to the bituminous coating a microwave-produced carbon black in an amount sufficient to increase the cycles-to-failure of the coating by at least about 10% compared to the same coating without the added microwave-produced carbon black, when tested for weathering according to ASTM D 4799-00.”

U.S. Pat. No. 6,562,119 also discloses that “Conventional carbon black has been tested numerous times to determine if its addition improves the weathering of asphalt-based coating materials, and uniformly it has not shown an improvement in weathering when testing the coating material using the Weatherometer test (ASTM Test Method D 4799-00). However, unlike conventional carbon black, it has been discovered that the addition of even a small amount of microwave-produced carbon black to a bituminous coating material substantially improves its weathering under this test.”

U.S. Pat. No. 6,562,119 also discloses that “In the method of the present invention, microwave-produced carbon black is added to a bituminous coating material in an amount sufficient to increase the cycles-to-failure of the coating material by at least about 10% compared to the same coating material without the added microwave-produced carbon black, and preferably at least about 15%. The cycles-to-failure of the coating material is measured by testing it for weathering according to ASTM D 4799-00, “Standard Test Method for Accelerated Weathering Test Conditions and Procedures for Bituminous Materials (Fluorescent UV and Condensation Method)”, published March 2000. Using Cycle A of the test method, the coating material is exposed to cycles of four hours of UV light at 60° C., alternating with fours hours of condensation at 50° C. The cycles are continued until the coating material fails due to cracking as determined by ASTM Test Method D 1670.”

ASTM Standard D 4798-04 uses shingle specimens that are 2.75 inches×5.875 inches. These shingle specimens preferably are subjected to “Cycle A,” in which they are exposed to multiple 24 hour cycles of exposure to (i) high intensity Xenon-Arc light, (ii) a combination of high intensity Xenon-Arc light exposure with water spray and (iii) cooling (see Practices G151 and G155) at 60 degrees Celsius

A multiplicity of such shingle specimens are used in the test. After a defined number of cycles, one of the weathered specimens is removed, examined for any signs of cracking or failure in accordance with ASTM D 1670 and then subjected to the tear test set forth in ASTM D 3462-05. If the specimen passes the tear test, the remaining specimens are then subjected to additional weathering cycles, after which one of the specimens is again removed, examined for signs of cracking or failure and subjected to the tear test. Failure is defined by the number of cycles required to have a weathered specimen exhibit cracking or fail the tear test.

It is preferred that the shingles of this invention, made in step 30, can be subjected to at least 10 cycles of weathering before they fail. In one embodiment, the shingles are subjected to at least 15 cycles of weathering before they fail. In another embodiment, the shingles are subjected to at least 20 cycles of weathering before they fail. In another embodiment, the shingles are subjected to at least 30 cycles of weathering before they fail. In one aspect of each of these embodiments, the asphalt shingle coating used to make such shingle had a filler loading of from about 71 to about 80 percent.

### Decrease of the Decline in Tear Resistance

In one preferred embodiment, applicants' shingle loses its tear resistance at a slower rate than do prior art shingles with comparable levels of mineral filler and asphalt. One can conduct the aforementioned weathering tests with both applicants' shingles and prior art shingles with comparable materials and loadings. Applicants' shingles will survive more cycles of weathering prior to failure. Furthermore, although they will also lose some tear resistance, at any particular level of weathering, the rate of loss of tear resistance for applicants' shingles will generally be lower than the rate of loss of tear resistance for prior art shingles. This can readily be indicated by plots of tear resistance over time; the slope of the plots for applicants' shingles will generally be lower.

Thus, unlike prior art shingles, which tend to fail relatively quickly after being put into use, applicants' novel shingle has durable properties that allows it use for an extended period at an acceptable level of performance.

### Decrease in Decline of Fastener Pull Through Resistance.

ASTM standard D 3462-05, in section 8.1.11, specifies tests for determining “Fastener Pull-Through Resistance.” When the test is conducted at a temperature of from about 21 to about 25 degrees Celsius, a single-layer shingle must have a pull through resistance of at least about 90 Newton's, and a multi-layer product must have a pull-through resistance of at least about 135 Newton's. When the test is conducted at a temperature of from about minus 2 degrees Celsius to about plus 2 degrees Celsius, a single-layer shingle must have a pull through resistance of at least about 104 Newton's, and a multi-layer product must have a pull-through resistance of at least about 180 Newton's. Both conditions must be met in order for a shingle to pass this ATSM standard test.

In one embodiment, after each ten cycles of weathering, two of the weathered samples are tested for fastener pull through resistance, one at each temperature.

In one preferred embodiment, applicants' shingle loses its fastener pull through resistance at a slower rate than do prior art shingles with comparable levels of mineral filler and asphalt.

One can conduct the aforementioned weathering tests with both applicants' shingles and prior art shingles with comparable materials and loadings. Applicants' shingles will survive more cycles of weathering prior to failure. Furthermore, although they will also lose some fastener pull through resistance, at any particular level of weathering, the rate of loss of fastener pull through resistance for applicants' shingles will generally be lower than the rate of loss of fastener pull through resistance for prior art shingles. This can readily be indicated by plots of fastener pull through resistance over time; the slope of the plots for applicants' shingles will generally be lower.

### Decline in the Decrease of Adhesion Between the Granules and the Shingle Composition

In one preferred embodiment, the decline in granule adhesion in applicant's shingles is less than that occurs in prior art shingles.

Granule adhesion may be measured by ASTM test D 4977-03, “Standard Test Method for Granule Adhesion to Mineral Surfaced Roofing by Abrasion.” If more than one gram of the granules is lost, the sample fails the test.

In one embodiment, after each cycle of weathering, one of the weathered samples is tested for granule adhesion.

In one preferred embodiment, applicants' shingle loses its granule adhesion at a slower rate than do prior art shingles with comparable levels of mineral filler and asphalt.

One can conduct the aforementioned weathering tests with both applicants' shingles and prior art shingles with comparable materials and loadings. Applicant's shingles will survive more cycles of weathering prior to failure. Furthermore, although they will also lose some granule adhesion, at any particular level of weathering, the rate of loss of granule adhesion will generally be lower than the rate of loss of granule adhesion for prior art shingles. This can readily be indicated by plots of granule adhesion over time; the slope of the plots for applicants' shingles will generally be lower.

### An Impact-Resistant Roofing Shingle

In one embodiment of the invention, applicants provide an impact resistant roofing shingle that passes Underwriter Laboratories Standard Test UL 2218. This test is disclosed in published United States patent application US 2005/0130519, the entire disclosure of which is hereby incorporated by reference into this specification.

In column 1 of such published United States patent application, it is disclosed that “Losses sustained to building roofs caused by climatic conditions such as hailstones has focused development of roofing shingles having increased impact resistance. This need in the art is particularly acute in those geographic areas which are subject to these climatic conditions. Specifically, such areas as the Plain and Rocky Mountain states are particularly subject to roofing damage caused by hailstorms and the like. Indeed, the insurance laws of the state of Texas provide cash rebates to ‘homeowners insurance policies wherein the insured property's roof employs Class 4 roof covering materials.”

United States published patent application US 2005/013519 also discloses that “The most recognized criteria for impact resistant roof covering materials is provided by Underwriters Laboratory Standard Test UL 2218, which is incorporated by reference. Standard Test UL 2218 categorizes roof covering materials as Class 1, 2, 3 or 4. Class 1 is the category assigned to the least resistant while Class 4 provides the highest recognized impact resistant.”

United States published patent application US 2005/013519 also discloses that “Impact resistant roofing materials are known in the art. For example, U.S. Pat. No. 6,228,785 discloses an asphalt-based roofing material which includes a substrate coated with an asphalt coating in which a surface layer of granules is embedded in its top surface. The bottom surface, covered with an asphalt coating, however, is bonded to a web. The bond between the asphalt coating and the web is effectuated by fusing of the asphalt coating and the web. This is achieved by intermingling, caused by melting, of the web and the asphalt coating.”

United States published patent application US 2005/013519 also discloses that “U.S. Pat. No. 5,571,596 describes an asphalt-coated roofing shingle, which includes an upper layer of a directional fiber such as Kevlar fabric, a middle layer of fibrous mat material, such as a glass fiber mat, and a lower layer of a directional fiber such as E-glass fabric. Unlike the teaching of the aforementioned '785 patent, wherein the web, fused to the lower region of the asphalt coating, provides impact resistance, the impact resistance of the roofing shingle of the '596 patent is ascribed to the lower layer of directional fiber.”

United States published patent application US 2005/013519 also discloses that “A third impact resistant roofing shingle is set forth in U.S. Pat. No. 5,822,943. The laminated roofing shingle of the '943 patent includes an upper layer of a scrim bonded, by means of an adhesive, to a lower layer mat. The preferred adhesive of the upper and lower layers is a rubber binder.”

United States published patent application US 2005/013519 also discloses that “In addition to the aforementioned impact resisting roofing material designs, it is well known in the art to modify the asphalt coatings of roofing materials with polymer-type modifiers. Such designs, although effective in theory, have not been very effective in resisting climatic impacts caused by hailstones and the like. On the other hand, modifying the asphalt with polymer-type additives increases the asphalt coating raw material cost. In addition, installation of modified asphalt is more difficult than standard unmodified asphalt coated roofing materials.”

United States published patent application US 2005/013519 also discloses that “The above remarks establish the need in the art for a new type of impact resistant roofing shingle that meets the most stringent impact resistant, e.g. Class 4 as defined in UL 2218, yet is simple in design and easy to manufacture.”

Applicants' roofing shingle, in one embodiment thereof, is “ . . . a new type of impact resistance roofing shingle that . . . ,” is at least Class 1 and, more preferably, at least Class 2. In one embodiment, applicants' roofing shingle is at least Class 3. In another embodiment, applicants' shingle is at least Class 4.

Without wishing to be bound to any particular theory, applicants believe that their roofing shingles provide improved impact resistance because the combination of the treated limestone or treated mineral filler with an oxidized roofing asphalt coating creates compound synergy and therefore stronger composition when incorporated into a glass mat and covered with roofing granules as previously described herein.

### Repetition of Process 10 to Optimize the Shingle Properties

Referring again to FIG. 1, and depending upon the results obtained in steps 22 and 32, additional testing can be conducted with new fillers (see step 34) and/or new asphalts (see step 36) and/or new additives (see step 24) in order to obtain both an efficient process and the best possible shingle properties.

In one embodiment, “optimized asphalt” (whose properties have been optimized in the manner described below) is mixed with an “optimized filler composition” (i.e., filler whose properties have also been optimized in the manner described below) to produce a composition which is unexpectedly superior to prior art compositions. In one aspect of this embodiment,

In this embodiment, one may use any of the filler materials that have heretofore been used for to fill asphalt for this purpose. Applicants' published United States patent application US 2007/0261337, the entire disclosure of which is hereby incorporated by reference into this specification, describes and claims several different filler materials and compositions that may be chosen for use in step 12 of the process.

The “Optimized Filler Composition” is preferably one that, when mixed with “Optimized Asphalt”, produces a filled asphalt coating, an “Optimized Shingle Coating Composition,” with a viscosity that is about ten percent lower than filled asphalt compositions produced with conventional fillers and conventional asphalts.

This embodiment of the invention provides those in the shingle manufacturing art an opportunity to optimize roofing production line speed, increasing the speed by at least five percent. Without wishing to be bound to any particular theory, and with regard to processes for making roofing shingles, applicants believe that this improvement is due to the improved ability of applicants' optimized filler composition to more rapidly saturate and coat the non-woven glass fabric commonly used in the production of roofing shingles.

By way of illustration and not limitation, one may use a commercially available bonded non-woven glass roofing fabric with a dry weight of approximately 92-95 grams/square meter, consisting of chemically sized individual “E” Glass filaments of 15.25-16.5 microns in diameter (“M” fiber) and from 0.75-1.25 inches in length, which are randomly oriented and bonded with a modified urea-formaldehyde resin binder, which has been applied to a level of 20 percent (dry weight). The fabric is often referred to in the art as a “glass roofing mat.”

The aforementioned glass roofing mat is typically coated on each side and saturated with a roofing asphalt compound consisting of the aforementioned asphalt shingle coating that preferably contains at least 65 percent of a mineral filler such as limestone or stone dust; such a composition is typically referred to in the trade as a “filled asphalt coating.” In one preferred embodiment of the present invention, the mineral filler used is a coated mineral filler of a certain particle size.

The optimized filled asphalt coating as previously described typically has a viscosity of between 2000 centipoise and 4500 centipoise when applied to the glass roofing mat at a temperature of between 425 degrees Fahrenheit and 475 degrees Fahrenheit. Such viscosity can be determined by ASTM standard test D 4402. It is preferred to utilize a process line speed that assures complete saturation of the glass roofing mat.

The fully saturated glass roofing mat may be referred to as “the warm sheet.” Roofing granules are typically applied to the top surface of the warm sheet by gravity feed, and the granules are roll pressed into the sheet with a roll pressure of between 10 pounds per square inch and 15 pounds per square inch. The finished sheet is allowed to cool to room temperature, and then it is cut into various patterns representing the types of shingles to be sold.

The use of this embodiment of applicants' invention allows manufacturers of roofing shingles substantially more flexibility in modifying their processes than was allowed with prior art filled asphalt coatings.

Thus, e.g., the roofing manufacturer can reduce the viscosity of the filled asphalt coating and thereby create the opportunity for compensatory adjustments in the manufacturing process to be made, specifically, increased line speed because of the improved ability to saturate the glass fabric more effectively.

Thus, e.g., the manufacturer may reduce the operating temperature required to process the filled asphalt coating and thus reduce the amount of energy consumed by the process. In these days of increased energy costs, this is a substantial advantage. Without wishing to be bound to any particular theory, applicants believe that the use of applicants' preferred filler compositions produces optimized filled asphalt coatings with reduced viscosity and thus provides the opportunity to reduce the filled asphalt coating process temperature by at least 5 degrees Fahrenheit while maintaining the same viscosity experienced with prior art filled asphalt compositions.

The production of asphalt roofing shingles is an energy intensive process. The filled asphalt coating typically used in the manufacture of roofing shingles typically has a viscosity of between 2000 centipoise and 4500 centipoise and is applied to the glass fabric at a temperature of between 425 degrees Fahrenheit and 475 degrees Fahrenheit, at a particular process line speed, to assure complete saturation of the glass roofing mat. One can modify a conventional prior art process with applicants' composition by either reducing the viscosity of the filled asphalt coating and/or reducing the coating temperature used to apply said coating to the glass roofing mat.

Alternatively, when the viscosity of the optimized filled asphalt coating increases, the roofing manufacturer may maintain the line speed but increase the process temperature. This alternative, although effective, requires more energy and this increases the cost of producing the roofing shingles. Furthermore, the use of a higher process temperature often necessitates the use of asphalts with higher flash points; these asphalts are relatively expensive.

Applicants' composition allows one to run a manufacturing process at lower coating temperatures and, thus, allows one to utilize lower quality asphalts and/or asphalts with lower flash points, thus affording the roofing manufacturer substantially more flexibility in securing acceptable and lower cost asphalts.

With prior art shingle manufacturing processes, and in order to avoid risk of a fire in the oxidation and roofing process, the petroleum based asphalt selected to be used to produce the asphalt shingle coating typically has a flash point of at least 550 degrees Fahrenheit. In one embodiment, with the use of applicants' composition, the asphalt used in such composition can have a flash point as low as 540 degrees Fahrenheit and, more preferably, as low as 530 degrees Fahrenheit.

The use of applicants' composition allows one to increase the “filler loading” in the optimized filled asphalt coating. The inorganic filler used in such compositions is typically much cheaper than the asphalt component; and an increase in the “filler loading” with a concomitant decrease in the “asphalt loading” substantially reduces the cost of producing such optimized filled asphalt coating while not adversely affecting the properties of the roofing shingles made from such coating.

The Manufacture of Asphalt Shingles with Reduced Asphalt Contents.

The manufacture of asphalt shingles is well described in the patent literature. Reference may be had, e.g., to U.S. Pat. Nos. 4,269,450 (asphalt shingle remover), 4,468,430 (asphalt shingle with glass fiber mat), 4,817,358 (asphalt shingle with foamed asphalt layer u tabs), 6,895,724 (laminated hip and ridge asphalt shingle), and 6,926,669 (methods and apparatus for recycling asphalt single materials). The entire disclosure of each of these United States patents is hereby incorporated by reference into this specification.

U.S. Pat. No. 4,328,147, the entire disclosure of which is hereby incorporated by reference into this specification, describes the “roofing felt” onto which the filled asphalt composition is applied. Such patent discloses that “Roofing felt from a continuous roll is coated with the asphalt formulation at about 400° F. Roofing granules, a colored ceramic stone baked onto stone granules, are pressed into the coating. The shingle color becomes the color of the granules. This coated felt roll is cooled and the shingles, with desired cut-outs, are continuously cut from the continuous shingle roll. Typically, the roll is three feet wide and shingles are one by three feet with cut-outs.”

U.S. Pat. No. 4,328,147 also discloses that “In recent years roofing felt material has been changed from cellulose to glass fibers. The new glass fiber shingle is thinner and more flexible than the old cellulose felt shingle. Therefore, the coating must have better flexibility properties, particularly at cold temperatures. If this is not the case, flexing at cold temperatures causes surface cracking in the shingles. The cracks are failure sites and points for future leaks to develop.”

“ASTM International” (of 100 Barr Harbor Drive, P.O. Box C700, West Conshohocken, Pa. 19428) has developed a “Standard Specification for Asphalt Shingles Made from Glass Felt and Surfaced with Mineral Granules,” D 3462-05. This standard has been widely accepted in the roofing industry as an authoritative criterion for the acceptability of fiberglass shingles.

Section 6 of ASTM D 3462-05 deals with “Dimensions, Masses and Permissible Variations.” Section 6.3 of this standard specifies that “The shingles shall confirm to the masses prescribed in Table 2.”

Table 2 of ASTM D 3462-05 appears on page 3 of such Standard, and it is entitled “Masses of Asphalt Shingles Made from Glass Felt.” In the last two lines of such table, it is specified that “Mass percent of mineral matter passing a No. 70 (212-μm) sieve based on the total asphalt and mineral matter passing the No. 70 (212-μm) sieve” shall be no greater than 70 percent.”

The specification that the shingle contain no more than about 70 weight percent of mineral filler with a particle size less than 212 microns was developed because of a belief that shingles containing more than this much “fine filter” would crack prematurely and/or fail the tear standard set forth in ASTM standard test D 3462-05 (and its predecessor ASTM standard test D 3462-03). As a result of this specification, and the widespread belief that asphalt shingles containing more than 70 weight percent of “fine filler” are unacceptable, many shingle manufacturers continue to make shingles comprised of from about 65 to about 69 weight percent of fine filler and from about 35 to about 31 weight percent of asphalt.

There is a widespread belief in the roofing industry that “excess mineral filler” with a particle size less than about 212 microns tends to remove essential oils from the asphalt in the roofing product and, consequently, cause cracking and premature failure of the shingle. This proposed failure mechanism is believed to be similar to the mechanism by which roofing shingles are believed to fail due to exposure to the sun. The asphalt component of roofing shingles degrades when subjected to heat, thereby releasing essential oils and weakening the bond between the asphalt and the roofing granules. As is disclosed on pages 7-8 of Mike Guertin's “Roofing with Asphalt Shingles” (The Taunton Press, Inc., Newtown, Conn., 2002), “All roof shingles will eventually degrade and fail. Except in cases of extreme weather conditions or events, the longevity of a roof is directly related to the quality of the asphalt and the strength of the heat from the sun. Heat robs asphalt of its oil, causing the shingle to become brittle. Brittle shingles crack and lose their protective granule surface coating, and the degradation process accelerates. When shingles lose patches of their granular surfacing, called spalling or blistering, the countdown to replacement should quicken. The exposed asphalt coating will deteriorate even more rapidly and precipitate further granule loss, which quickly leads to leaks.”

Even with “fine mineral filler” compositions less than about 70 percent, many of the asphalt shingles made today fail prior to the time their warranty period expires. Thus, e.g., many shingles that are warranted for 20, 30, or even 40 years fail after no more than about 15 years of use.

In accordance with one embodiment of the invention, there is provided an optimized composition comprised of 71 to 75 weight percent of mineral filler material with a particle size less than 212 microns and 25 to about 29 weight percent of asphalt. When the composition is incorporated into a glass felt mat with a density of from about 1.8 to about 1.9 pounds per 100 square feet and made into a single-layer roofing shingle, the shingle, after having been subjected to at least 10 cycles of Cycle A of ASTM standard test D 4798-04, has a tear resistance of at least 1,700 grams.

In one preferred embodiment, an optimized filler composition is added to a optimized non-oxidized asphalt and polymer composition to manufacture a lower cost modified bitumen roofing membrane for use on commercial roofing projects or as self sticking sealing membranes such as may be used under roofing shingles as ice and water shield membrane. The use of applicants' composition allows one to increase the “filler loading” in the modified asphalt. The inorganic filler used in such compositions is typically much cheaper than the asphalt or polymer component; and an increase in the “filler loading” with a concomitant decrease in the “modified asphalt loading” substantially reduces the cost of producing such filled composition while not adversely affecting the properties of the roofing membranes made from such modified asphalt. In this embodiment, the filler loading for such membrane compositions can be increased by at least 10 percent and preferably by as much as 25 percent with no loss of durability or strength characteristics.

In one preferred embodiment, an optimized filler composition is added to a optimized non-oxidized asphalt or non-oxidized asphalt and polymer composition to manufacture an adhesive composition for various commercial uses such as adhesives and crack-fillers. The use of applicants' composition allows one to increase the “filler loading” in the modified adhesive. The inorganic filler used in such compositions is typically much cheaper than the asphalt or polymer component; and an increase in the “filler loading” with a concomitant decrease in the “asphalt loading” substantially reduces the cost of producing such filled composition while not adversely affecting the properties of the adhesive membranes made from such composition. In this embodiment, the filler loading for such adhesive compositions can be increased by at least 10 percent and preferably by as much as 25 percent with no loss of tack, durability or strength characteristics.

### Alternative Mineral Filler Compositions

In this section of the specification, applicants will describe certain mineral filler compositions that, in addition to the fillers already described, may be used in step 12.

One may use any of the mineral fillers known to those skilled in the art as starting materials in the process 10 of this invention. Reference may be had, e.g., to U.S. Pat. Nos. 4,276,661 (mineral filler, method of preparation, and use thereof), 4,280,949 (modified polyester compositions containing mineral filler), 4,372,814 (paper having mineral filler for use in the production of gypsum wallboard), 4,421,678 (electrically conductive compositions comprising an ethylene polymer, a mineral filler, and an oiled, electrically conductive carbon black), 4,470,877 (paper having calcium sulfate mineral filler for use in the production of gypsum wallboard), 4,487,879 (filled arylene sulfide polymer compositions containing a glass filter in combination with a mineral filler), 4,661,164 (method of tinting a mineral filler), 4,876,291 (mineral filler fire retardant composition and method), 5,494,953 (polypropylene composition with high content of heavy mineral fillers), 5,676,729 (particulate urea with mineral filler incorporated for hardness), 6,177,499 (acrylic sheet having uniform distribution of coloring and mineral filler), 6,706,148 (method for fixing a mineral filler on cellulosic fibers), and the like. The entire disclosure of each of these United States patents is hereby incorporated by reference into this specification.

The mineral filler used in step 12 may be a mineral stabilizer. As is known to those skilled in the art, and as defined in ASTM standard test D 1079-05 (“Standard Terminology Relating to Roofing and Waterproofing”), a mineral stabilizer is a fine, water-insoluble inorganic material, used in admixture with solid or semisolid bituminous materials. Reference may be had, e.g., to U.S. Pat. Nos. 3,650,786 (oil well cement), 4,190,568 (mineral stabilized resin emulsion), 4,472,243 (sheet type roofing), 4,588,634 (coating formulation for inorganic fiber mat based bituminous roofing shingles), 4,952,268 (laminated waterproofing material containing asphalt), and 6,616,755 (self-leveling concrete). The entire disclosure of each of these United States patents is hereby incorporated by reference into this specification.

### Mixtures of Mineral Stabilizer

In one embodiment, the filler used in step 12 of this invention is a mixture of two different minerals with different particle sizes and/or particle size distributions and/or chemical compositions and/or physical properties. In one aspect of this embodiment, two or more minerals with different particle sizes and/or different particle size distributions are blended to obtain a blended mineral stabilizer with a specified particle size distribution. In another aspect of this embodiment, two more or distinct fractions of the same mineral are blended to form a blended mineral stabilizer with a specified particle size distribution.

### The Particle Size Distribution of Filler and its Concentration.

In one embodiment, the filler chosen in step 12 has a sufficient number of its particles smaller than 212 microns that the weight of such fine particles is at least about 70 weight percent of the combined weight of such fine particles and asphalt; and the concentration of asphalt in such composition is preferably less than about 30 weight percent and, more preferably, less than about 29 weight percent.

In one embodiment, the filler chosen in step 12 has a sufficient number of its particles smaller than 212 microns that the weight of such fine particles is at least about 71 weight percent of the combined weight of such fine particles and asphalt; and the concentration of asphalt in such composition will preferably be less than about 28 weight percent and, more preferably, less than about 27 weight percent.

In one embodiment, the filler chosen in step 12 has a sufficient number of its particles smaller than 212 microns that the weight of such fine particles is at least about 72 weight percent of the combined weight of such fine particles and asphalt; and the concentration of asphalt in such composition will be less than about 26 weight percent and, more preferably, less than about 25 weight percent.

In one embodiment, the filler chosen in step 12 has a sufficient number of its particles smaller than 212 microns that the weight of such fine particles is at least about 73 weight percent of the combined weight of such fine particles and asphalt.

In one embodiment, the filler chosen in step 12 has a sufficient number of its particles smaller than 212 microns that the weight of such fine particles is at least about 74 weight percent of the combined weight of such fine particles and asphalt.

In one embodiment, the filler chosen in step 12 has a sufficient number of its particles smaller than 212 microns that the weight of such fine particles is at least about 75 weight percent of the combined weight of such fine particles and asphalt.

In one preferred embodiment, the filler chosen in step 12 has a sufficient number of its particles coarser than 70 microns such that the weight of such coarse fraction is at least 60 weight percent of the total weight of the mineral stabilizer.

In one preferred embodiment, the filler chosen in step 12 has a sufficient number of its particles finer than 3.35 millimeters and coarser than 212 microns such that the weight of such is at least about 25 weight percent of the total weight of the mineral stabilizer.

In one preferred embodiment, less than about 2 percent of the particles in the mineral filler chosen in step 12 are coarser than 250 microns. In one aspect of this embodiment, less than about 1.5 percent of the particles in the mineral filler are coarser than 250 microns.

In one embodiment, at least 65 weight percent of the particles in the mineral filler are smaller than 74 microns.

In another embodiment, at least 80 weight percent of the particles in the mineral filler are smaller than 74 microns.

In yet another embodiment, at least 85 weight percent of the particles in the mineral filler are smaller than about 74 microns.

One may prepare any desired particle size distribution by conventional means. Thus, e.g., by way of illustration and not limitation, one may grind limestone and thereafter classify the various fractions. After such classification has occurred, one may then recombine selected fractions to produce the desired particle size distribution.

### Properties of the Coated Mineral Filler

In one preferred embodiment, the coated mineral filler produced in step 26 of this invention is comprised of a coating on such particulate matter with a thickness of from about 200 to about 2000 nanometers and, preferably from about 300 to about 1200 nanometers.

Means for providing such a coated filler material are described elsewhere in this specification.

### Properties of the Asphalt Used in the Roofing Shingle

In one preferred embodiment, the asphalt used in the process of this invention (see step 14) is comprised of two or more blended oxidized asphalts.

In one preferred embodiment, the asphalt used in the process of this invention (see step 14) is replaced, in whole and/or part, with one or more asphalt modifiers. These asphalt modifiers are well known to those skilled in the art. Reference may be had, e.g., to U.S. Pat. Nos. 4,560,414 (modifier for paving asphalt), 5,393,819 (asphalt modifier), 5,399,598 (asphalt composition), 5,990,206 (asphalt modifier composition and asphalt composition), 6,503,968 (asphalt modifier of styrene-butadiene-styrene block copolymer), and the like. The entire disclosure of each of these United States patents is hereby incorporated by reference into this specification.

Reference also may be had, e.g., to Chapter 8 (“Polymeric Modifiers for Improved Performance of Asphaltic Mixtures”) of Arthur M. Usmani's “Asphalt Science and Technology,” Marcel Dekker, Inc., New York, N.Y. 1997).

In general, the asphalt binder that is used in the process of this invention (see step 14) may be replaced, in whole or in part, by one or more of the binder materials that are known to have been used in roofing shingles. Reference may be had, e.g., to U.S. Pat. Nos. 3,848,384 (composition shingle), 3,931,440 (roofing shingle using an asphalt composition), 4,273,685 (rubber modified asphalt compositions), 4,392,371 (asphalt compositions modified with organo-silane compounds), 4,301,851 (chemically modified asphalt compositions), 4,316,829 (modified asphalt composition), 4,322,928 (asphalt composition shingles), 4,332,705 (asphalt compositions modified with a rubbery polymer), 4,335,186 (chemically modified asphalt compositions), 4,338,231 (modified asphalt compositions), 4,349,388 (asphalt compositions modified with organo-silane compounds), 4,378,447 (cationic amine modified asphalt compositions), 4,384,073 (cationic alkenyl azabenzene chemically modified asphalts), 4,384,074 (cationic chemically modified asphalts), 4,394,481 (cationic acrylamide and rubber modified asphalts), 4,394,482 (modified asphalt composition), 4,404,316 (chemically modified asphalt compositions), 4,548,650 (diatomite-modified asphalt), 4,677,146 (modified asphalt compositions comprising a nitrogen derivative of an esterified copolymer), 4,833,184 (acrylate-modified asphalt), 4,850,844 (apparatus for making tapered plastic shingles), 4,868,233 (polyethylene modified asphalts), 5,019,610 (polymer-modified asphalts and asphalt emulsions), 5,059,300 (asphalts modified by solvent de-asphalted bottoms and phosphoric acid), 5,095,055 (acid treated polymer modified asphalts), 5,256,710 (phenolic-type polymer modified asphalts), 5,290,355 (roofing shingle composition), 5,331,028 (polymer modified asphalt compositions), 5,364,894 (emulsification of asphalt and modified asphalt with primary emulsifier polymers comprised of acrylic acid type monomers), 5,451,621 (SBS-modified asphalt-based material), 5,460,852 (polymer modified asphalt coating), 5,660,014 (composite shingle having shading zones in different planes), 5,571,596 (advanced composite roofing shingle), 5,851,276 (crumb rubber modified asphalt), 5,866,211 (rubber modified asphalt), 5,891,224 (rubber modified asphalt), 5,973,037 (styrene ethylene butylenes styrene copolymer rubber modified asphalt), 6,150,439 (polymer modified asphalt), 6,444,731 (modified asphalt), 6,569,925 (polymer modified asphalt), 6,713,539 (storage-stable modified asphalt compositions), 6,818,687 (modified asphalt with carrier and activator material), 6,884,431 (modified asphalt with partitioning agent), and the like. The entire disclosure of each of these United States patents is hereby incorporated by reference into this specification.

### A Flame-Retarded Roofing Composition

In one preferred embodiment, the roofing composition of this invention, in addition to containing the aforementioned mineral filler, also contains a flame-retarded asphaltic composition with which the mineral filler is mixed prior to the time it is used to impregnate the glass felt.

One may use any of the flame-retarded asphalt compositions known to those in the art including, e.g., those disclosed in U.S. Pat. Nos. 4,804,696 (flame retardant asphalt composition), 5,026,747 (flame retardant asphalt composition), 5,102,463 (flame retardant asphalt composition), 5,168,817 (flame retardant modified asphalt-based material), and the like. The entire disclosure of each of these United States patents is hereby incorporated by reference into this specification.

By way of illustration, and as is disclosed in U.S. Pat. No. 5,168,817, “To impart flame retardancy, it is known to add halogenated olefinic elastomers, fillers such as antimony trioxide, decabromo diphenyl oxide, chlorinated alicyclic hydrocarbon, alumina trihydrate, and chlorinated or brominated paraffins, as is discussed in U.S. Pat. Nos. 4,839,412 and 4,851,463. More specifically, others have attempted to impart flame retardancy to asphalt compositions containing vinyl copolymers by the addition of monoammonium phosphate, ammonium sulfate and methyl hydrogen polysiloxane as in U.S. Pat. No. 4,804,696; by the addition of potassium citrate and methyl hydrogen polysiloxane as in U.S. Pat. No. 5,026,747; by the addition of brominated diphenyl ether, antimony oxide and zinc borate as in U.S. Pat. No. 5,100,715; by the addition of ammonium sulfate, methyl hydrogen polysiloxane, muscovite mica and magnesium silicate as in U.S. Pat. No. 5,102,463; by the addition of colemanite as in U.S. Pat. No. 5,110,674; and by the addition of at least one halogenated flame retardant and at least one inorganic phosphorus containing compound as in U.S. Pat. No. 4,659,381.”

Applicants have found that the use of such flame-retarded asphalt in their roofing compositions and the shingles made therefrom imparts excellent and durable flame retardant properties.

The Viscosity Index of the Particles of this Invention

Applicants have discovered that the coated particles of their invention, when used in a specified asphaltic coating composition, provides a viscosity for such composition that is at least ten percent lower than the viscosity of a comparable composition made from substantially identical particles that are not coated. Thus, and in this embodiment, the viscosity of the mixture of heated filler (unmodified) and heated asphalt is at least 10 percent higher than the viscosity of a comparable composition at a comparable filler loading wherein the heated filler is coated with one or more of the viscosity-reducing agents of this invention.

In the viscosity index test, and in one embodiment, standard limestone filler such as Franklin Industrial Minerals Grade 85/200 is used.

In the viscosity index test, and in one embodiment, two separate mixtures of asphalt and limestone filler are prepared, each at a loading of 65 weight percent of the filler (by weight of the asphalt and the filler); and the viscosities of the filled asphalt coating containing relatively high levels of filler loading are measured over a range of temperatures reflecting the temperatures encountered on roofing machines, i.e. from 425 degrees Fahrenheit to 475 degrees Fahrenheit.

Applicants have discovered that the viscosity of the hot filled asphalt composition made using the particles of their invention is at least about ten percent lower than the viscosity of the hot filled asphalt composition made using the specified particles of the prior art. The ratio of the initial viscosity of the composition made using this invention to the second viscosity of the composition using prior art is preferably less than 0.9 and, in one embodiment, is less than about 0.86; this ratio is the “viscosity index.”

In one embodiment, the particles of this invention have a contact angle index of least about 1.1 and, more preferably, at least about 1.2. The contact angle index is the contact angle of the particles of this invention divided by the contact angle of the “standard filler” described hereinabove with reference to the viscosity index test. Such a contact angle may be measured by means well known to those skilled in the art. Reference may be had to U.S. Pat. Nos. 5,861,946 (contact angle measurements of a substrate), 5,423,218 (instrument for measuring contact angle), 5,080,484 (method of measuring contact angle of wetting liquid on a solid surface), 4,688,938 (method and apparatus for determining the contact angle of a drop of liquid placed on a solid or liquid horizontal substrate), 3,696,665 (contact angle measurement of plastic surfaces), and the like. The entire disclosure of each of these United States patents is hereby incorporated by reference into this specification.

In one embodiment, the particles of this invention have a specified particle size distribution. It is preferred that at least 25 weight percent of such particles are within the range of sizes 3.35 millimeters to 212 microns. In one aspect of this embodiment, at least about 50 weight percent of such particles are within such range and, more preferably, at least about 75 weight percent of such particles are within such range.

In one embodiment, the particles of this invention have a specified particles size distribution. It is preferred that at least 25 weight percent of such particles are within the range of sizes 3.35 millimeters to 212 microns. In one aspect of this embodiment, at least about 50 weight percent of such particles are within such range and, more preferably, at least about 75 weight percent of such particles are within such range.

In one embodiment, it is preferred that at least 25 weight percent of such particles are within the range of sizes from 1.0 millimeter to 212 microns. In one aspect of this embodiment, at least about 50 weight percent of such particles are within such range and, more preferably, at least about 75 weight percent of such particles are within such range.

In one embodiment, it is preferred that at least 85 weight percent of such particles are smaller than 212 microns.

In one embodiment, at least 25 weight percent of such particles are smaller than 149 microns.

In one embodiment, some but not all of the particles are coated with an organic coating. In one aspect of this embodiment, at least 80 weight percent of the particles that are smaller than 100 microns are coated with such organic coating, and less than about 10 weight percent of the particles that are bigger than 150 microns are coated with such organic coating.

In one embodiment, some but not all of the particles are coated with an organic coating. In one aspect of this embodiment, at least 65 weight percent of the particles that are smaller than 75 microns are coated with such organic coating, and less than about 15 weight percent of the particles that are bigger than 150 microns are coated with such organic coating.

In one embodiment, at least 65 weight percent of said particles are coated with such organic coating and, more preferably, at least about 75 weight percent of said particles are coated with said organic coating.

In one embodiment, some but not all of the particles are coated with an organic coating. In one aspect of this embodiment, at least 50 weight percent of the particles that are smaller than 50 microns are coated with such organic coating, and less than about 10 weight percent of the particles that are bigger than 100 microns are coated with such organic coating.

### Use of Treated Filler in Polymer Modified Asphalt Membranes

In one preferred embodiment, a treated limestone filler composition is added to a non-oxidized asphalt and polymer composition to manufacture a lower cost modified bitumen roofing membrane for use on commercial roofing projects or as self sticking sealing membranes such as may be used under roofing shingles as ice and water shield membrane. The use of applicants' composition allows one to increase the “filler loading” in the modified asphalt. The inorganic filler used in such compositions is typically much cheaper than the asphalt or polymer component; and an increase in the “filler loading” with a concomitant decrease in the “modified asphalt loading” substantially reduces the cost of producing such filled composition while not adversely affecting the properties of the roofing membranes made from such modified asphalt. In this embodiment, the filler loading for such membrane compositions can be increased by at least 10 percent and preferably by as much as 25 percent with no loss of durability or strength characteristics.

### Use of Treated Filler in Asphalt Adhesives and Crack Fillers

In one preferred embodiment, a treated limestone filler composition is added to a non-oxidized asphalt or non-oxidized asphalt and polymer composition to manufacture an adhesive composition for various commercial uses. The use of applicants' composition allows one to increase the “filler loading” in the modified adhesive. The inorganic filler used in such compositions is typically much cheaper than the asphalt or polymer component; and an increase in the “filler loading” with a concomitant decrease in the “asphalt loading” substantially reduces the cost of producing such filled composition while not adversely affecting the properties of the adhesive membranes made from such composition. In this embodiment, the filler loading for such adhesive compositions can be increased by at least 10 percent and preferably by as much as 25 percent with no loss of tack, durability or strength characteristics.

### EXAMPLES

The following examples are presented to illustrate the claimed invention but are not to be deemed limitative thereof. Unless otherwise stated, all parts are by weight and all temperatures are in degrees Fahrenheit.

In the experiments described in the examples, the limestone filler material used was an 85/200 mineral filler sold by Franklin Industrial Minerals that is described elsewhere in this specification. In the experiments described, from 0.5% to 1.5% of a coating was deposited onto such filler material; in most of the examples, and unless otherwise specified, the concentration of the coating additive was 0.5 weight percent.

The asphalts used in the experiments of these examples were typical shingle coating asphalts provided by one or more parties. Both the asphalt and the treated mineral filler material were separately heated in the same oven to a temperature of about 350 degrees Fahrenheit for 3 hours until a stable and uniform temperature was obtained for both of these materials. Thereafter, the heated treated mineral filler material was mixed with the heated asphalt material.

In such experiments, a pre-measured amount of heated asphalt was charged into a metal container and was mixed with a wooden spatula while being heated by a hot plate so that its viscosity was maintained at from 500 to about 3000 centipoise and its temperature was maintained at from about 350 to about 400 degrees Fahrenheit. While the asphalt was being thus heated and stirred, the heated limestone was added with continued stirring. Sufficient amounts of filler and asphalt were charged to the premeasured asphalt in order to provide a filler loading weight of 65 percent (by combined weight of asphalt and filler). After such addition, the mixing was then continued for from about 2-3 minutes, by hand, and the hot mixture was then transferred to a thermal cell adapted to heat such mixture while determining its viscosity at various temperatures. The viscosity of the mixture tested test by a viscometer; the viscometer that was used was the Brookfieled DV-II+Brookfield Viscometer equipped with a thermocell and an SC4-27D spindle in accordance; and testing was conducted in accordance with ASTM D 4402 at a spindle speed of 20 rpm. This device had a built-in temperature probe, and it was capable of displaying the viscosity of the hot mixture as its temperature was varied.

In the experiments described in most of the examples, the filler material was typically coated with an additive at a concentration of 0.5 weight percent, unless otherwise specified. The additives used were commercially available materials. such as, e.g., (1) L-100 naphthenic mineral oil, either by itself or in a 50%/50% blend with ACRA 500, (2) the asphalt additives sold by the ArrMaz Custom Chemicals company of 4800 State Road 60 East, Mulberry, Fla. 33860, such as these additives include, e.g., “AD-here HP Plus,” “ACRA 500,” “AD-here LOF 65-00, and “AD-here 64-10,” and (3) a polyamine agent known as “PAVEBOND LITE” and sold by the Morton International Company.

### Examples 1-4

In these Examples, various asphalts were used. In Example 1, the asphalt was an asphalt shingle coating obtained from the GAF-Elk Corporation's plant at Ennis, Tex. (“GE”). In Example 2, the asphalt was an asphalt shingle coating obtained from the Houston, Tex. plant of the Owens Corning Corporation (“OH”). In Example 3, the asphalt used was an asphalt shingle coating obtained from the Irving, Tex. plant of the Owens-Corning Corporation (“OI”). In Example 4, the asphalt used was an asphalt shingle coating obtained from the Jacksonville, Fla. plant of the Owens Corning Corporation (“OJ”).

The treated filler samples were coated with 0.5 weight percent of the specified coating agent. The coating agents were “L-100,” a naphthenic mineral oil, HP Plus (an epoxylated polyamine obtained from ArrMaz Custom Chemicals), and a 50/50 mixture of the L-100 (a napthenic mineral oil), PaveBond (an epoxylated polyamine obtained from the Rohm & Haas Corporation), stearic acid and ACCRA-500 additive

The results of these experiments are shown in TABLE 1.

TABLE 1
Viscosty, cps

| | | Asphalt & | Asphalt & | Asphalt & | Asphalt & | Asphalt & |
|---|---|---|---|---|---|---|
| | Asphalt | L-100 | ACRA 500 | HP Plus | Stearic | PaveBond |
| | w/Untreated | Treated | Treated | Treated | Treated | Treated |
| Example | Filler | Filler | Filler | Filler | Filler | Filler |
| 1 | 4300 | 2725 | 2675 | 5888 | 4925 | 6625 |
| 2 | 6163 | 3863 | 3888 | 11800 | 6913 | 8850 |
| 3 | 4613 | 3138 | 2650 | 6988 | 5713 | 4025 |
| 4 | 4513 | 3363 | 3213 | 4525 | 5325 | 4738 |

### Examples 5-13

In the experiments described in these examples the asphalt used was an asphalt shingle coating obtained from the Tuscaloosa, Ala. plant of the GAF Corporation (“GT”). In the experiments of Examples 5, 6, and 7, the concentration used for the additive was 0.5 weight percent. In the experiments described in examples 8, 9, and 10, the concentration used for the additive was 1.0 weight percent. In the experiments described in Examples 11, 12, and 13, the concentration of the additives was 1.5 weight percent. The results of these experiments are presented in TABLE 2.

TABLE 2
Viscosty, cps

| | Asphalt | Asphalt & | Asphalt & | Asphalt & |
|---|---|---|---|---|
| Exam- | w/Untreated | L-100 | ACRA 500 | Stearic |
| ple | Filler, | Treated Filler | Treated Filler | Treated Filler |
| 5 | 6907 | 6612 | — | — |
| 6 | 6907 | — | 6825 | — |
| 7 | 6907 | — | — | 7312 |
| 8 | 6907 | 6875 | — | — |
| 9 | 6907 | — | 4638 | — |
| 10 | 6907 | — | — | 6513 |
| 11 | 6907 | 5862 | — | — |
| 12 | 6907 | — | 4350 | — |
| 13 | 6907 | — | — | 6763 |

### Examples 14-15 (See Tables 3 and 4)

Some of the additives that were used in the prior experiments were also used here. In addition, and experiment was conducted with AD-here 6410 (an epoxylated amine sold by the Arrmaz Custom Chemicals company).

In the experiment of example 14 the asphalt was “GI”. In example 15 the asphalt was “OH.”

Some of the experiments reflect the effects of the additive when added to the asphalt. Others of these experiments reflect the effects of the additive that is coated onto the filler, and the coated filler is then mixed with the asphalt.

TABLE 3
Viscosty, cps

| | | Asphalt | Asphalt | Asphalt | Asphalt | Asphalt | Asphalt | Asphalt |
|---|---|---|---|---|---|---|---|---|
| | | Treated w/ | Treated | Treated w/ | Treated w/ | Treated w/ | Treated w/ | Treated |
| | Asphalt | Stearic w/o | w/HP Plus | ACRA 500 | PaveBond | LOF-6500 | AD-HERE 640 | w/L-100 |
| Example | w/o filler | filler | w/o filler | w/o filler | w/o filler | w/o filler | w/o filler | w/o filler |
| 14 | 850 | 625 | 625 | 638 | 638 | 638 | 800 | 700 |

TABLE 4
Viscosty, cps

| | | Asphalt | Asphalt | Untreated | Untreated | Untreated |
|---|---|---|---|---|---|---|
| | | Treated w/ | Treated w/ | Asphalt | Asphalt & | Asphalt & |
| | Asphalt | Stearic w/o | PaveBond | w/Untreated | Stearic Treated | PaveBond |
| Example | w/o filler | filler | w/o filler | Filler | Filler | Treated Filler |
| 15 | 850 | 625 | 638 | 7088 | 8125 | 5263 |

### Examples 16-21

In the examples of experiments 16-18, the Asphalt used was an Asphalt Shingle Coating “GT.” The results are shown in TABLE 5.

In the experiments described in Examples 19-21 different Asphalt materials were used. In example 19 an Asphalt Shingle Coating obtained from the Tuscaloosa, Ala. plant of GAF was used. In example 20 an Asphalt Shingle Coating obtained from the Houston, Tex. plant of the Owens Corning plant was used. In example 21 an Asphalt Shingle Coating obtained from the Jacksonville, Fla. plant of Owens Corning was used. In one embodiment of each of these examples, a 50/50 mixture of L/100 naphthenic mineral oil and ACRA 500 were used. The results are shown in TABLE 6.

TABLE 5
Viscosty, cps

| | Asphalt | Asphalt & | Asphalt & | Asphalt & |
|---|---|---|---|---|
| Exam- | w/Untreated | L-100 | Stearic | HP Plus |
| ple | Filler | Treated Filler | Treated Filler | Treated Filler |
| 16 | 6694 | 5863 | — | — |
| 17 | 6694 | — | 5675 | — |
| 18 | 6694 | — | — | 8900 |

TABLE 6
Viscosty, cps

| | Asphalt | Asphalt & | Asphalt & L-100 - |
|---|---|---|---|
| Exam- | w/Untreated | L-100 | ACRA 500 |
| ple | Filler | Treated Filler | Treated Filler |
| 19 | 6663 | 6238 | 5363 |
| 20 | 5475 | 4388 | 4438 |
| 21 | 5188 | 3938 | 3900 |

### Example 22

In this experiment, the Asphalt used was an Asphalt Shingle Coating obtained from the Tuscaloosa, Ala. plant of GAF. The additives tested at 410 degrees Fahrenheit were such Asphalt with stearic acid treated filler such additive with HP plus treated filler such additives with ACRA 500 treated filler. The results are presented in TABLE 7.

TABLE 7
Viscosty, cps

| | | Asphalt | Asphalt | Asphalt | Asphalt | Asphalt | Asphalt w/ | Asphalt |
|---|---|---|---|---|---|---|---|---|
| | Asphalt | w/Stearic | w/HP Plus | w/ACRA 500 | w/PaveBond | w/LOF-6500 | AD-HERE 6410 | w/L-100 |
| | w/untreated | treated | treated | treated | treated | treated | treated | Treated |
| Example | filler | filler | filler | filler | filler | filler | filler | filler |
| 22 | 6694 | 5675 | 8900 | 5450 | 8675 | 8550 | 8388 | 5863 |

We claim:

1. A process for making a composition comprised of asphalt and filler, comprising the steps of spraying a viscosity reducing additive onto particles of shingle filler material to produce coated shingle filler material, heating said coated shingle filler material to produce a heated coated shingle filler material, heating said asphalt to provide a heated asphalt, and mixing said heated coated shingle filler material with said heated asphalt.

2. The process as recited in claim 1, wherein said coated shingle filler material is comprised of particles that comprise an inorganic core, wherein at least about 60 weight percent of said particles are smaller than about 212 microns.

3. The process as recited in claim 2, wherein said shingle filler material is limestone, and at least 90 weight percent of said shingle filler material is calcium carbonate.

4. The process as recited in claim 3, wherein said limestone is comprised of at least 60 percent of particles less than 212 microns in size but greater than 74 microns in size.

5. The process as recited in claim 4, comprising the steps of mixing from about 25 to about 29 weight percent of said heated asphalt with from about 75 to about 71 weight percent of said coated shingle filler material (by combined weight of said asphalt and said shingle filler material).

6. A composition comprised of from about 71 to about 75 weight percent of mineral filler material with a particle size less than 212 microns and from about 25 to about 29 weight percent of asphalt (by combined weight of said asphalt and said mineral filler with a particle size smaller than 212 microns) wherein, when said composition is incorporated into a glass felt mat with a density of from about 1.8 to about 1.9 pounds per 100 square feet and made into a single-layer roofing shingle, said shingle, after having been subjected to at least 10 cycles of Cycle A of ASTM standard test D 4798-04, has a tear resistance of at least 1,700 grams.”

7. The composition as recited in claim 6, wherein said mineral filler with a particle size less than 212 microns is limestone.

8. The composition as recited in claim 7, wherein said limestone is comprised of at least about 90 weight percent of calcium carbonate.

9. A roofing shingle that, after it has been subjected to at least 10 cycles of Cycle A of ASTM standard test D 4799-03, will have a tear resistance of at least 1,700 grams, wherein said shingle is comprised of a roofing composition disposed within a glass felt mat, and wherein said roofing composition is comprised of from about 25 to about 29 weight percent of asphalt and from about 75 to about 71 weight percent of mineral filler material with a particle size of less than about 212 microns (by combined weight of said asphalt and said mineral filler material).

10. The roofing shingle as recited in claim 9, wherein said mineral filler material with a particle size less than 212 microns is limestone.

11. The roofing shingle as recited in claim 10, wherein said limestone is comprised of at least about 90 weight percent of calcium carbonate.

12. The roofing shingle as recited in claim 11, wherein said limestone is comprised of at least 60 percent of particles less than 212 microns in size but greater than 74 microns in size.

13. The roofing shingle as recited in claim 10, wherein said composition is comprised of from about 25 to about 28 percent of said asphalt.

14. The roofing shingle as recited in claim 10, wherein said composition is comprised of from about 25 to about 27 percent of said asphalt.

15. The roofing shingle as recited in claim 10, wherein said roofing shingle, after having been subjected to at least 10 cycles of Cycle A of ASTM standard test D 4798-04, has a Class 1 impact resistance, as measured by Underwriter's Laboratory standard test UL 2218.

16. The roofing shingle as recited in claim 10, wherein said roofing shingle, after having been subjected to at least 10 cycles of Cycle A of ASTM standard test D 4798-04, has a Class 2 impact resistance, as measured by Underwriter's Laboratory standard test UL 2218.

17. The roofing shingle as recited in claim 10, wherein said roofing shingle, after having been subjected to at least 10 cycles of Cycle A of ASTM standard test D 4798-04, has a Class 3 impact resistance, as measured by Underwriter's Laboratory standard test UL 2218.
